(19) United States
(12) Patent Application Publication
(10) Pub. No.: US 2005/0195076 A1
(43) Pub. Date: Sep. 8, 2005

(54) Intelligent message delivery system

(75) Inventors: William R. McCulloch, Broomfield, CO (US); Craig J. Lund, Louisville, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: CARETOUCH COMMUNICATIONS, INC., Boulder, CO (US)

(21) Appl. No.: 11/053,692

(22) Filed: Feb. 7, 2005

Related U.S. Application Data
(60) Provisional application No. 60/542,651, filed on Feb. 5, 2004.
(60) Provisional application No. 60/547,115, filed on Feb. 24, 2004.
(60) Provisional application No. 60/547,264, filed on Feb. 24, 2004.

(51) Int. Cl. G08B 23/00

(52) U.S. Cl. 340/500

(57) ABSTRACT

A system for delivering messages to a subscriber of a notification application. The system includes a plurality of available script templates defining formats for scripts, a message builder receiving application-specific data and building a script based on a previously unused script template, and merging the application-specific data with the script, and a message delivery module causing a human-understandable message to be delivered to the subscriber, the human-understandable message being generated from the script. A method for delivering a message to a recipient includes receiving an application message including one or more codes corresponding to script segments, mapping each of the codes to an associated script segment from a script component data set, the script component data set including a set of script segments that express a common meaning with a different phrase, generating a script composed of the associated script segments, and causing a human-understandable message to be delivered to the recipient, wherein the human-understandable message is based on the generated script.

### RELATED APPLICATIONS

This application claims benefit of U.S. Provisional Application No.60/547,115, filed Feb. 24, 2004, entitled “Communication of Health Status Information,” U.S. Provisional Application No. 60/542,651 filed Feb. 5, 2004, entitled “An Intelligent Call Broadcast Communications Engine,” and U.S. Provisional Application No. 60/547,264, filed Feb. 24, 2004, entitled “Automated Distribution of Custom Messages Pertaining to the Birth of a Child,” which are incorporated herein by reference for all that they disclose.

### BACKGROUND

In many settings, individuals want to be notified about something or someone of interest, but do not necessarily have first hand knowledge. Often another entity, such as a service provider, has the first hand knowledge, but for many reasons, that information is not communicated effectively to interested individuals. An assisted living environment is one such example. When a person is admitted to an assisted living facility, such as a nursing care facility or an assisted living facility, it becomes difficult for family and friends of the person to keep informed about the person's health and day-to-day activities. Practical, business, and legal obstacles often stand in the way of communicating valuable information to friends and family.

Because of demands involved with operating a nursing care facility, it is difficult for many nursing care facilities to keep nursing care facility residents' family and friends informed about the residents. Clinicians and staff at the nursing care facility typically spend most of their time tending to the needs of the residents. Therefore, nursing care facility staff typically do not have time to notify all the family and friends of residents about the resident. Because labor is typically the largest operating expense for nursing care facilities, most nursing care facilities do not hire a full time employee to regularly provide information about the residents to their family and friends.

In addition, communications difficulties are compounded by busy lifestyles of friends and family who are geographically dispersed. Consequently, a convenient time to call for the interested party is not necessarily a convenient time for the resident and vice versa. Unfortunately, often the family or friends of the resident only receive information when a health emergency has arisen.

Furthermore, privacy rules mandated by the Health Insurance Portability Accountability Act of 1996 (HIPAA) place additional burdens on health care providers and nursing care facilities to regulate access to patient health information. Therefore, it is incumbent upon nursing care facilities to secure authorization prior to releasing private information.

Yet another problem related to communication of nursing care information relates to the ability of the family or friends to understand the technical terms and medical lingo often used in the nursing care industry. The family members and friends are typically not experts in the field of medicine or nursing care. Indeed, family and friends are typically laypersons without specialized knowledge. Unfortunately, clinicians and other health care providers at nursing care facilities find it difficult to relate information in a nontechnical way. Family and friends are often frustrated with the highly technical medical jargon that they receive.

### SUMMARY

Apparatus and methods are described for a flexible communications platform architecture. Broadly stated, embodiments of the present invention can provide a flexible and secure communications infrastructure that can support the needs of various computer telephony and web-based message delivery systems.

In embodiment of a system for delivering messages to a subscriber of a notification application includes a plurality of available script templates defining formats for scripts, a message builder receiving application-specific data and building a script based on a previously unused script template, and merging the application-specific data with the script, and a message delivery module causing a human-understandable message to be delivered to the subscriber, the human-understandable message being generated from the script.

An embodiment of a method for delivering a message to a recipient includes receiving an application message including one or more codes corresponding to script segments, mapping each of the codes to an associated script segment from a script component data set, the script component data set including a set of script segments that express a common meaning with a different phrase, generating a script composed of the associated script segments, and causing a human-understandable message to be delivered to the recipient, wherein the human-understandable message is based on the generated script.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary operating environment in which an embodiment of an intelligent message delivery system can operate;

FIG. 2 is a block diagram including functional modules and data structures in an exemplary embodiment of the intelligent message delivery system;

FIG. 3 illustrates an embodiment of a message building scheme that may be carried out by the message builder of the intelligent message delivery system;

FIG. 4 illustrates an exemplary scenario showing an exemplary message that might be received by the message builder and an exemplary script that might be generated for use in creating a human-understandable message;

FIGS. 5-15 illustrate embodiments of algorithms that can be carried out using the intelligent message delivery system; and

FIG. 16 illustrates is an exemplary computing device with which embodiments of the present invention may be implemented.

### DETAILED DESCRIPTION

Apparatus and methods are described for a flexible communications platform architecture. Broadly stated, embodiments of the present invention can provide a flexible and secure communications infrastructure that can support the needs of various computer telephony and web-based message delivery systems.

Some embodiments include a message delivery system, which receives a message including codes related to a subject for delivery to a targeted recipient. A human-understandable message is generated using a script component data structure that defines translations between codes and script segments. A script component data structure can be extensible and can include application-specific script components. Another script component data source can include industry-specific script components. Application-specific script components can be created, edited, and expired by a notification service that provides notification applications for the recipient. The message delivery system can choose from available script templates to facilitate freshness of messages that are delivered to the target.

According to one embodiment the communications infrastructure may support many different subscription services offerings, such as message delivery systems having a primary account and associated members (e.g., a predefined distribution community to which customized messages are to be delivered).

In accordance with one embodiment, the script component data source can include multiple script components having a common meaning wherein each of the multiple script components expresses the common meaning in a different style. One of the multiple script-components is selected for inclusion in a message when a script template is created.

In some embodiments, message freshness is preserved by delivering human-understandable messages in a substantially non-repetitive order. In accordance with one embodiment, a previously unsent script template is selected at random to generate the human-understandable message for delivery. In accordance with this and other embodiments, when all the available script templates have been used, the least recently delivered script template is selected to generate the human-understandable message. Delivery of the message can be logged with time and date of delivery.

In accordance with a particular embodiment, the human-understandable message is delivered in audio format. In this embodiment, the human-understandable message is composed of tag data readable by a text-to-speech (TTS) system, which converts the script into an audio message. The audio message is delivered to the target via an audio output device, such as a computer speaker or telephone.

In accordance with some embodiments, the human-understandable message is delivered securely. According to these embodiments, the identity of the target can be verified prior to delivery of the human-understandable message. Verification may include verification of biometric data. Verification can also include verification of private information from the target. Verification may include verification of a smartcard. Verification can also involve use of a public key infrastructure (PKI) to verify the target and/or the intelligent message delivery system.

In accordance with a particular embodiment, the script component data source can include one or more application-specific script components. In accordance with this embodiment, application-specific script components can relate to a nursing care facility, or a long term assisted living, or the like. Also in accordance with this embodiment, the application-specific script components can relate to a daycare environment. Also in accordance with this embodiment, the application-specific script components can relate to a new-born baby notification environment. Also in accordance with this embodiment, the application-specific script components can relate to an automotive maintenance notification environment.

According to some embodiments, a subscriber can retrieve a human-understandable message from the intelligent message delivery system. In these embodiments, the subscriber can call a specified phone number and, after authentication, receive the human-understandable message in an audible form.

According to one embodiment, an intelligent message delivery system (IMDS) is a core software engine providing services that allow for inbound subscriber transactions and produce outbound subscriber specific information based on the subscriber's profile. The IMDS is capable of defining a top level application product (such as a baby notification system, health care status messaging system, or a health care education system), accepting information from this product, creating messages based on the application's profile elements, and delivering the messages on behalf of the application.

The term “human-understandable” refers to the ability of a human to readily perceive the meaning of something (e.g., a script or message). Thus, generally codes are not human-understandable because codes do not mean anything to a human until they are translated or converted into a form that can be understood by a human. A human-understandable message contains meaningful information about a subject. In certain embodiments, a human-understandable message includes readable text in a format commonly understood by a recipient of the message. In other embodiments, a human-understandable message includes audible statements including words and phrases that would commonly be understood by a recipient. Thus, a human-understandable message can be embodied in a variety of formats including, but not limited to, an audio file (e.g., .wav, .mp3., .au), a text file (e.g., an email message, a web page), a audio/video file (e.g., .ram, .avi), or others.

A “message” generally refers to the content of a communication transmitted by electronic means, such as an email message, telephone or other audio channels, a paging network, radio, or the like to the distribution community.

A “script” generally refers to one or more associated script segments and/or one or more data elements. A script may be represented by a data structure that links related script segments together with data elements. A script may also be represented by concatenated, aggregated, or otherwise combined or processed script segments.

A “script component” is an association between at least a script component identifier and a script segment. The script component may also include a segment name, value, or other information.

A “script segment” generally refers to information that can be readily converted into speech or text representing a human understandable word, phrase or statement. One or more script segments joined with one or more data elements when concatenated together form a script. According to one embodiment, a script segment may be represented as a snippet of text (e.g., one or more words stored as text strings). Alternatively, script segments may be retrieved from a relational database or derived from informational content of a relational database (e.g., numeric values, text strings, and/or enumerated values). According to one embodiment, script segments may be stored in native speech format, such as .wav files representing pre-recorded speech samples or pre-synthesized words, phrases or statements. The term “target” generally refers to a subscriber or member to whom a message or script is to be delivered. A “recipient” is generally one who receives a message or script or for whom a message or script is intended.

The terms “product-specific” and “application-specific” are used interchangeably to designate data that is specific to an application product (e.g., a program, software, system) that performs tasks related to notification to recipients.

In the following description, for the purposes of explanation, numerous specific details regarding an existing commercial embodiment are set forth in order to provide a thorough understanding of the present invention. It will be apparent, however, to one skilled in the art that the present invention may be practiced without some of these specific details. In other instances, well-known structures and devices are shown in block diagram form.

Exemplary System and Architecture

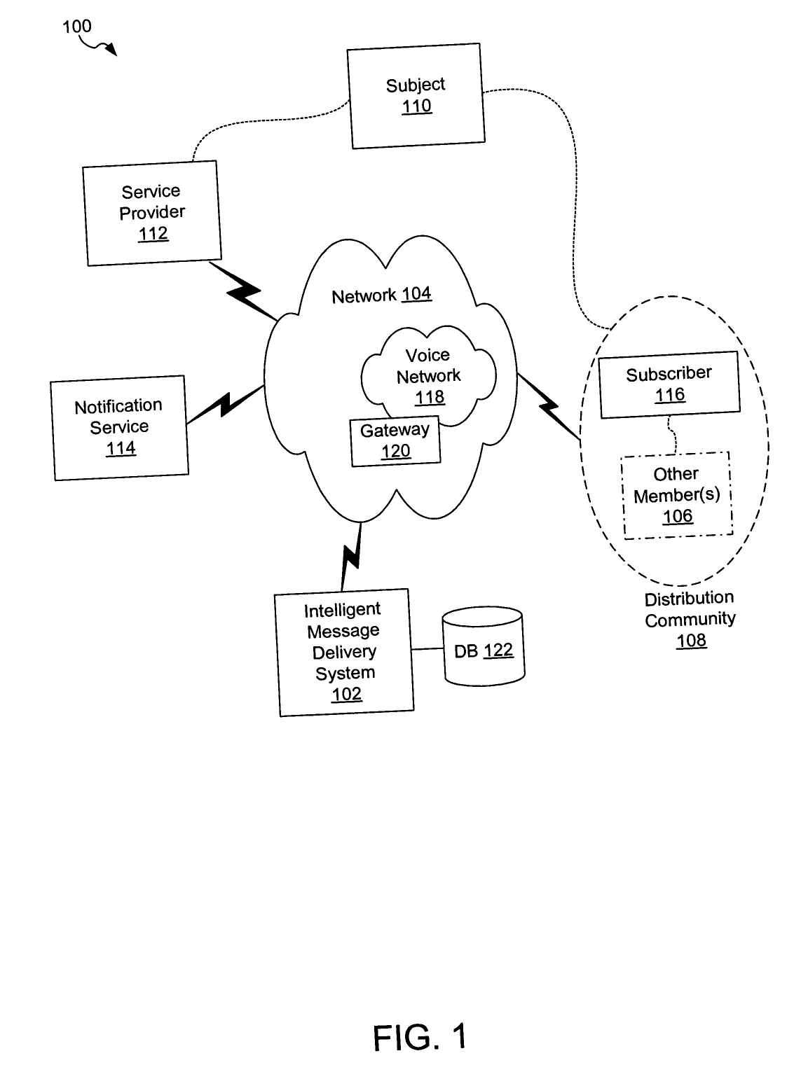

FIG. 1 illustrates an exemplary operating environment 100 in accordance with one embodiment of the present invention. In the particular embodiment shown, an intelligent message delivery system (IMDS) 102 communicates via a network 104 to deliver messages to a subscriber 116 and other member(s) 106 of a distribution community 108. The messages generally relate to a subject 110 that is associated with the distribution community 108 in some way. A service provider 112 provides a service with respect to the subject 110. At least part of the service includes generating or obtaining information about the subject 110. A notification service 114 receives the subject information from the service provider 112 via the network 104. The IMDS 102 then receives data from the notification service 114 that enables the IMDS 102 to build and deliver a message.

For convenience, FIG. 1 illustrates one notification service 114, one service provider 112, one subject 110, and one distribution community 108. However, it will be understood that in general, there can exist multiple notification services 114, multiple service providers 112, multiple subjects 110, and multiple distribution communities 106. As is discussed in detail below, the IMDS 102 includes scalable features that enable intelligently processing and delivering messages related to many different subjects 110 from many different notification services 114 and/or service providers 112 to many different distribution communities 106.

Indeed, the IMDS 102 is scalable to be able to handle messages related to many different industries and environments.

A subject 110 is someone or something about which the subscriber 116 or other member(s) 106 have an interest in being notified. In one embodiment, the subject 110 could be a resident of an assisted living facility, such as a nursing care facility. In this embodiment, the service provider 112 represents the assisted living facility, or a caregiver that cares for the resident. The assisted living facility in this case generates various information about the resident, such as health status, activities of daily living, personal needs, and others, which can be compiled into a message for delivery to the member(s) 106. In this case, the member(s) 106 of the distribution community 108 are typically relatives or friends of the resident who want to keep informed about the health and wellbeing of the resident.

In another embodiment, the subject 110 may be an automobile owned by the subscriber 116. In this embodiment, the service provider 112 could represent the automobile dealership. In this case, the automobile dealership gathers information about the automobile, such as upcoming automobile servicing dates, part recalls, rebates, and others, which can be compiled into a message. Using this automobile information, the IMDS 102 may send a scheduled (e.g., monthly) message to the subscriber 116 related to the automobile.

In yet another embodiment, the subject 110 may be a newborn baby. In this case, the subscriber 116 can use the notification service 114 to announce the birth of the newborn baby. For example, the subscriber 116 can specify the member(s) 106 who will receive the announcement. When the baby is born, the notification service 114 can cause the IMDS 102 to deliver the announcements.

In yet another embodiment, the subject 110 could be a group membership, such as a membership to a reading club or professional organization. In this embodiment, the service provider 112 could represent the group administrator who generates information about group events, subscription dues, and others. The IMDS 102 builds a message using the group membership information and delivers it to the distribution community 108.

Referring to the distribution community 108, typically a subscriber 116 in the distribution community 108 registers with the notification service 114 to use one or more applications offered by the notification service 114. The subscriber's 116 subscription may or may not require a fee.

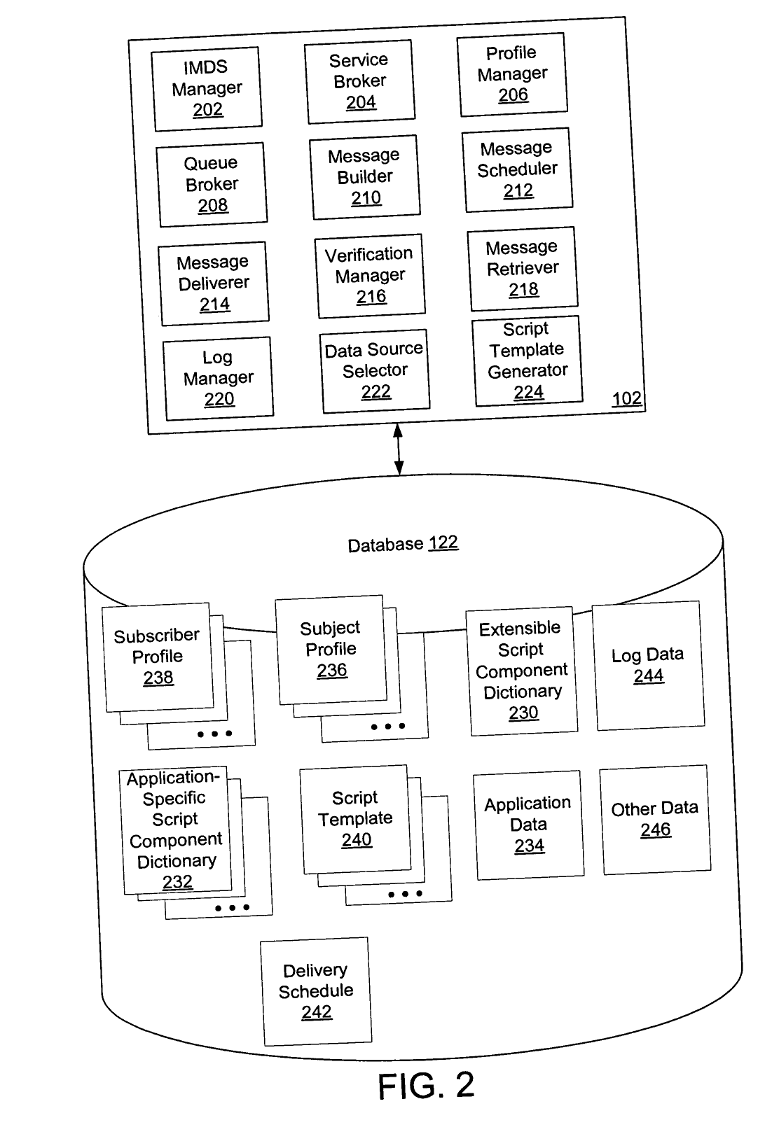

When registering, the subscriber 116 specifies information related to his registration. The information is stored in a subscriber profile (e.g., subscriber profile 238, FIG. 2), described in detail below. The subscriber profile identifies one or more of the subscriber, the subject 110, service level, preferred time(s) to be notified, payment information (e.g., credit card), relationship to the subject 110, member(s) in the distribution community 108, and other data. Profile information for members who are not subscribers may also be included in the associated subscriber's profile.

Referring to an embodiment of the notification service 114, applications offered by the notification service 114 provide services related to notification of the distribution community 108, service provider 112, or others, of relevant information. In one embodiment, the notification service 114 compiles information from the service provider 112 and generates a series of corresponding codes and/or data elements. The notification service 114 sends the series of codes and/or data elements to the IMDS 102, which builds a human-understandable message based on the codes and/or data elements and causes the message to be sent to a specified recipient in the distribution community 108.

In another embodiment, an application product from the notification service 114 communicates responses from a recipient in the distribution community to the service provider 112. In another embodiment, the application product handles requests from the recipient. For example, in the case of an assisted living environment, the recipient may request that an item be purchased for the subject 110 (in this case a resident of the assisted living facility). In response, the notification service 114 can order the item and have the item delivered to the service provider 112 (in this case, the assisted living facility). The requested item may be ordered from an on-line retailer via the network 104.

The applications offered by the notification service 114 and the information provided by the applications typically depend upon the subject 110. For example, when the subject 110 is a resident of an assisted living care provider, the application will typically offer information related to the resident's status (e.g., health, activities, events, etc.). However, when the subject 110 is an automobile owned by the subscriber 116, the information provided by the application will include information related to the automobile (e.g., scheduled oil change, tune-up, recall, etc.). Although the embodiments discussed below relate to an assisted living environment (e.g., a nursing care facility), based on the embodiments described herein, those skilled in the art will readily recognize how to adapt the embodiments to other environments.

In one embodiment, applications provided by the notification service 114 provide an user interface (e.g., a web interface) to the service provider 112. A user at the service provider 112 accesses the user interface to record data related to the subject 110. For example, in the case of an assisted living facility, a clinician (the user) may enter data related to health status of a resident. The user interface can be designed to facilitate the data entry by presenting a standard set of questions. The application gathers the user's answers to the questions. In one embodiment, the data entered by the user is associated with predefined codes that correspond to predefined script segments, which include human-understandable text expressing the meaning of the data.

In one embodiment, messages are sent to subscribers 116 on a regularly scheduled basis (e.g., once per week). The timing of messages is based on the subscriber's 116 specified preferred time to receive messages. Thus, the schedule can vary from one subscriber 116 to another. Because messages are delivered according to a schedule, the notification service 114 periodically obtains application message data from the service provider 112. The application message data may be obtained using a “push” mechanism (e.g., the service provider 112 sends it to the notification service), or by a “pull” mechanism (e.g., the notification service retrieves the data from the service provider 112). To facilitate delivery of the messages to the subscriber 116, the notification service 114 uses the IMDS 102. Advantageously, the IMDS 102 can use the application message data to build messages that are different each time a message is sent to the subscriber 116, so that messages are fresh to the subscriber 116.

In one embodiment, each notification service 114 registers with the IMDS 102 to employ the IMDS 102 to deliver messages on behalf of the notification service 114. Registration may be facilitated via the network 104, whereby the IMDS 102 provides an interface through which notification service 114 can register. The IMDS 102 provides flexibility in the manner and format of communication to the distribution community 108. For example, the IMDS 102 can provide a basic set of script components, but can also allow each notification service 114 to define its own set of script components or build upon the basic set. Script components defined by each notification service 114 can be application-specific. In addition, the IMDS 102 can provide sets of industry-specific script components, which can be selected by each notification service 114. As such, the IMDS 102 can serve many different types of application products from notification services 114 in many different fields and industries.

The IMDS 102 can cause the human-understandable message to be delivered in a secure or nonsecure fashion. In one secure embodiment, the IMDS 102 transmits an email message to member(s) 106 via the network 104. In this embodiment, the message can be stored on a server that is accessible to the member(s) 106. The email message can contain a hyperlink to the human-understandable message on the server. When the recipient member(s) 106 click on the hyperlink, they are directed to a secure login webpage, through which the recipient member(s) 106 login prior to viewing the message. Such a login could include entering a user name and password. Secure delivery via the network 104 may also involve use of a public key infrastructure (PKI).

In another secure embodiment, the IMDS 102 utilizes biometric verification. Biometric verification can include fingerprint verification, iris verification, voice verification, and others. Using biometric verification, the human-understandable message is not delivered unless the recipient is confirmed to be an authorized recipient.

For example, in an embodiment utilizing voice verification, the IMDS 102 can employ a voice network 118. The voice network 118 can include a voice over internet protocol (VOIP) network and can be in communication with a public switched telephone network (PSTN). The IMDS 102 transmits the script and member(s) 106 contact information (e.g., a phone number) to a voice gateway 120. The voice gateway 120 includes text-to-speech (TTS) capability and can convert the script into an audio message. The voice gateway 120 calls the member(s) 106 via the voice network 118. When the call is answered, the voice gateway 120 accepts input from the speaker via an automated speech recognition system, and verifies whether the voice of the speaker who has answered the call matches a voice print of the member(s) 106 who is intended to receive the script.

In another embodiment, the speaker who answers the call is verified using pin number or other password. In this embodiment, dual tone modulation frequency (DTMF) can be used by the voice gateway to identify alphanumeric entry by the speaker. Based on the alphanumeric entry, the IMDS 102 determines whether the speaker is authorized based on a predefined password or pin number.

FIG. 2 is a block diagram illustrating exemplary functional modules and data structures in a particular embodiment of an IMDS 102. The various functional modules and data structures shown can be implemented in hardware, software, firmware, or any combination of those. Generally, the modules include interfaces that enable the modules to communicate with each other, as well as to external systems that are utilizing the IMDS 102.

In a particular embodiment, the IMDS 102 is implemented in a hypertext transport protocol (HTTP) server and a database server. In this embodiment, the data structures can be implemented in a relational database 122 that is accessible by functional modules executing on the HTTP server. Some of the functional modules provide interfaces to the data structures, enabling creation, deletion, editing, and access to the information in the data structures. Among other functionality, the IMDS 102 can be used to manage applications, build messages, deliver messages, and handle responses to the messages, just to name a few.

An IMDS manager module 202 manages interaction with applications provided by notification services. In this capacity, the IMDS manager module 202 handles registration of applications that want to use the IMDS 102 for message delivery. In one embodiment, registration of the application is web-based, wherein a web form is completed online. The web form prompts for and accepts data that identifies the application, such as the name and location. In addition, the web form prompts for and accepts information to enable interaction with the application, such as, but not limited to, interface definitions, data elements, data element types, and script components.

In accordance with an embodiment, the IMDS manager module 202 accepts new script components when the application is registered or after registration. In this embodiment, a user, such as an application administrator is presented with application data categories or elements. For each application data category or element, the application administrator can enter a corresponding script component (e.g., a script segment). The IMDS manager module 202 compiles the new script components into a data structure referred to as an extensible script components data dictionary 230. After a script component is entered into the IMDS 102, it is an active script component, which means that it may be retrieved from the data structure and used to build messages for delivery to member(s) of the distribution community.

According to some embodiments, after script components are entered into the IMDS 102, active script components can be expired. Via an interface (e.g., a web form), the application administrator is presented with a list of active script components, each of which can be selected for expiration. When the selected script components are submitted for expiration, the IMDS manager 202 deactivates (e.g., deletes, marks for nonuse, etc.) them within the data structure.

Because the IMDS 102 can be utilized by a broad range of applications in different industries, script components can be offered or employed based on the particular application or industry. An application-specific script component dictionary 232 is generated when an application is registered. The application-specific script component dictionary 232 defines associations between data categories, elements, or values used by the application and script segments, codes, or other data. The data categories, elements, and values can be those that are used as a standard in the industry.

In one embodiment, the application-specific dictionary 232 is produced by a notification service offering the application. At registration time, the notification service sends the application-specific dictionary 232 to the IMDS 102. The application-specific dictionary 232 will specify codes (e.g., component Ids) that will be used during operation when messages are recorded. The application-specific component dictionary 232 can include industry-specific components. For example, in the assisted living industry, industry-specific script components can include data categories from the minimum data set (MDS) 2.0, which are standard for that industry.

In another embodiment, the IMDS 102 can offer selectable sets of industry-specific script components that different notification services can select. For example, sets of industry-specific script components can be offered for the automotive industry, the health education industry, and others. At registration time, the appropriate set of industry-specific script components can be selected.

In accordance with an embodiment, a service broker module 204 enables affiliate applications to be registered with the IMDS 102. The service broker module 204 interfaces with the notification service to register affiliate applications. An affiliate application is another application affiliated with a primary application that can be offered by the notification service. In some embodiments, an affiliate application can be an extension of another primary application concerning a subject. In other embodiments, an affiliate application may be separate from a primary application and pertain to a different subject. Application information is stored in application data structure 234.

In accordance with an embodiment, a profile manager 206 enables management of profiles related to subscribers and/or registered subjects. Through an interface to the profile manager 206, notification services can upload one or more subject profiles 236 and/or subscriber profiles 238 to the IMDS 102. Subject profiles include information pertinent to the subject. In the case of subjects who are people, a subject profile 236 can include, but is not limited to, name, address, nicknames, hobbies, birth date, health conditions, or categories of information that the subject allows to be released. When the subject is an item, such as an automobile, the profile 236 can include, but is not limited to, make, model, year, color, purchaser, or purchase date. Subscriber profiles 238 include information related to the subscriber such as name, address, service level, categories of information that the subscriber is interested in, member(s) in the distribution community, contact information, billing information (e.g., credit card), and so on.

After receiving the profiles, the profile manager 206 stores them so that they can be used later during the message building and delivery process. Embodiments of the profile manager 206 also allow for profiles 234, 236 to be edited and/or deleted.

In accordance with an embodiment of the IMDS 102, a queue broker 208 manages initiation of processes within the IMDS 102. The queue broker 208 receives requests to perform transactions, such as building or delivering messages. The queue broker 208 puts transactions on a queue to be initiated at selected execution times.

An embodiment of the IMDS 102 includes a message builder 210 that builds a message to be delivered to a recipient (e.g., subscriber and/or members of a distribution community). In one embodiment, the message builder 210 receives key information defining the message and identifying the recipient. The key information could include a subscriber's profile 238, the subject's profile 236, a history of previous script templates that have been delivered to the recipient, or other data.

In one embodiment, the message builder 210 uses the key information and one or more available script templates 240 to build a script that can be delivered to the recipient in the form of a human-understandable message. Generally, a script template 240 specifies the format of the script. In this embodiment, the message builder 210 selects one of the available script templates 240 using script selection criteria. Script selection criteria generally refers to rules or tests used to determine which script template 240 should be used to generate the script.

In one embodiment, a script template 240 is selected based on what script templates have been used in the past. In this embodiment, the message builder 210 generates a historical list of script templates 240 that have been used to create messages for delivery to the recipient. Based on the list, the message builder 210 identifies one or more script templates among the set of available script templates 240 that have not been used to generate a human-understandable message. The message builder 210 can select from the unused available script templates 240 in a random fashion, in order of receipt or creation, or in some other order. In one embodiment, if all of the available script templates 240 have been used, the message builder 210 selects the least recently used script template 240.

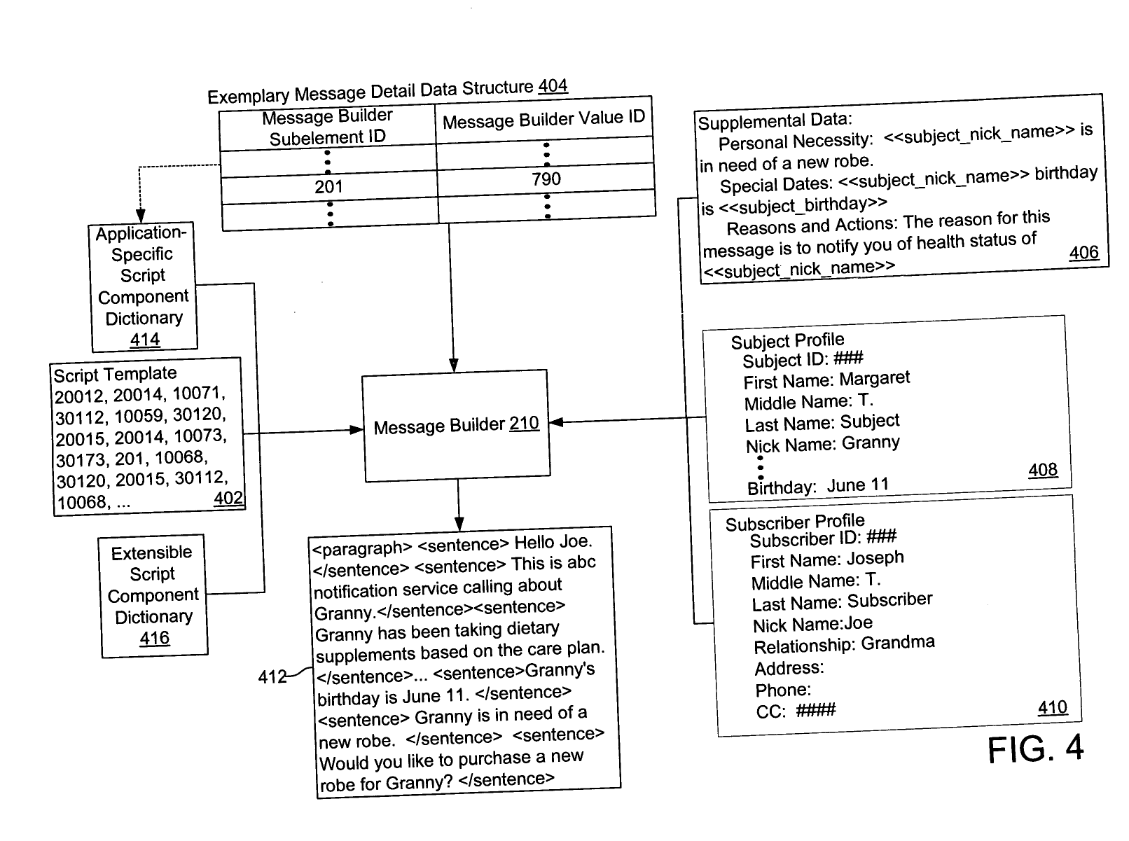

In one embodiment, the script templates 240 can be generated when an application is registered by a notification service and/or when subject profiles 236 and subscriber profiles 238 are received. Typically, multiple script templates 240 are created that can be used to express human-understandable ideas in a number of different ways. For example, a different introductory greeting may be included in different script templates 240. As another example, the order of categories of data within the script may be different for different script templates 240. In this manner, messages delivered to the recipient can be different from one delivery to the next, thus achieving freshness of the messages. The script templates 240 can be manually created by a user at the IMDS 102 or the script templates 240 can be obtained from another source, such as the notification service. Script templates 240 are illustrated in more detail below in regard to FIG. 4 with a particular exemplary scenario using a script template.

Another module, the message scheduler module 212 performs tasks related to scheduling delivery of messages to recipient(s). In one embodiment, delivery is via telephone. In this embodiment, the message scheduler module 212 schedules a telephone call based on the subscriber profile 238, in which the subscriber previously specified a preferred message delivery time window. The message scheduler module 212 can further refine the scheduled time based on system call capacity information. Call capacity information specifies the number of calls that can be handled by the IMDS 102, which can depend on the available hardware and telephone services.

In accordance with one embodiment, after the message scheduler module 212 determines a delivery time, the script from which the human-understandable message will be generated is stored in a delivery schedule 242. The delivery schedule 242 can include a number of call slots. Generally, a call slot is an entry in memory that associates a scheduled time with a message to be delivered at that time. The delivery schedule 242 can include the call slots for all scheduled messages for an upcoming time range (e.g., next week). When the scheduled time arrives for a particular call, the scheduled call is triggered for delivery.

Embodiments of the IMDS 102 include a message delivery module 214, which facilitates delivery of human-understandable messages according to the delivery schedule 242. In one embodiment, the message delivery module 214 communicates the script and recipient contact information to a voice gateway 120. The voice gateway then converts the human-understandable message to audio, using text-to-speech (TTS) functionality. In another embodiment, the message delivery module 214 communicates the script and recipient contact information to a HTTP Web interface. The script can be stored as a human-understandable text message or human-understandable audio file on the HTTP Web interface. For example, the script may be converted to a .wav, .mp3, .au, or other audio file.

A verification module 216 performs tasks related to verifying users (e.g., authorized members or unauthorized members) who attempt to access registered applications. The verification module 216 can use any verification scheme, such as, biometric verification, password verification, pin number verification. The verification module 216 interacts with subscriber profiles 238 to obtain verification information to compare to user input.

A message retriever 218 enables authorized members to retrieve previously generated human-understandable messages. The message retriever 218 can accept calls from users and interact with the verification module 216 to verify whether users are authorized prior to delivering requested messages. In one embodiment, the message retriever 218 presents a user interface to the authorized user through which the user can select a message. The script associated with a selected message is then delivered using the message delivery module 214.

A log manager 220 logs data during IMDS 102 execution. The log manager 220 stores the data in log data structure 244. Exemplary data that may be logged includes time and date of delivery of messages. Other data 246 represents any other data that may be required by the IMDS 102 to perform its operations.

In some embodiments, a data source selector 222 is operable to select data sources other than the data sources within the IMDS 102. Typically, the data source selector 222 is used to select any data that is not captured through the message recorder of the notification service, but through some vendor provided data recording system. For example, in the case of an assisted living facility, the vendor provided data recording system could be a clinical charting system such as those offered by MCKESSON, ADL DATA SYSTEMS, or KEANE. In these cases, the data source selector 222 is able to select an appropriate data source (e.g., via the network 104), utilizing a data source's metadata definition associated with the data source, from which to gather the data.

A script template generator 224 can generate the script templates 240. In one embodiment, the script template generator 224 presents a user interface through which a user at the IMDS 102 can define script templates 240. In an alternative embodiment, the script template generator 224 receives script templates from another source, such as a notification service, and stores the received script templates 240 in the database 122.

Note that in this description, in order to facilitate explanation, the IMDS 102 and the database 122 are each generally discussed as if it is a single, independent network device or part of single network device. However, it is contemplated that the IMDS 102 and the database 122 may each actually comprise multiple physical and/or logical devices connected in a distributed architecture; and the various functions performed may actually be distributed among multiple of such physical and/or logical devices. Additionally, in alternative embodiments, the functions performed by each of the IMDS 102 and the database 122 may be consolidated and/or distributed differently than as described. For example, any function can be implemented on any number of machines or on a single machine. Also, any process may be divided across multiple machines. Finally, encryption may be performed at various levels of the application flow. For example, encryption may be performed on the scripts, or data structures within the database 122.

While data structures are shown as being embodied in a relational database 122, it will be understood by those skilled in the art that any data storage and/or association mechanism can be used. In some embodiments, data structures, such as the application-specific script component dictionary 232 or the extensible script component dictionary 230, may be embodied in one or more flat files. In other embodiment, the data structures may be embodied in spreadsheets.

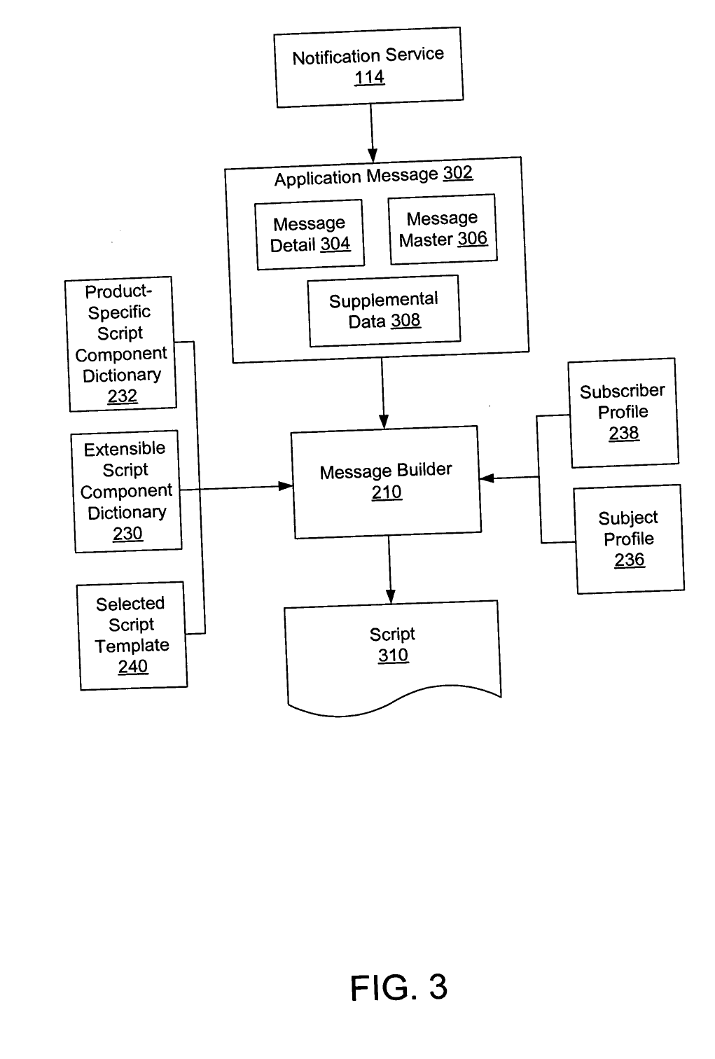

FIG. 3 illustrates an embodiment of a message building scheme. The notification service 114 generates an application message 302. Generally, the application message 302 describes data related to a subject for delivery to a recipient. The data is typically obtained by a notification service 114 from a service provider 112 and put into a format useable by the IMDS 102.

In the particular embodiment, the application message 302 includes a message detail data structure 304, a message master data structure 306, and supplemental data 308. In this embodiment, the application message 302 generally defines the components that will be used to generate a script that can be used to generate a corresponding human-understandable message.

Elements of an exemplary message master data structure 306 are shown below:
MSG_BLDR_MASTER_ID: Unique ID for each row created
MSG_BLDR_CHAIN_SERVICE_PROVIDER_ID: ID for the application-specific script component definition
MSG_BLDR CHAIN ID: ID for the chain
MSG_BLDR_SERVICE_PROVIDER_ID: ID for the service provider
MSG_BLDR_SUBJECT_ID: ID for the subject
MSG_BLDR_SERVICE_PROVIDER_USER_ID: ID for the service provider user
MSG_BLDR_DATE: Date of the recording, format of “YYYYMIDDHH24MI”

Elements of an exemplary message detail data structure 308 are shown below:
MSG_BLDR_MASTER_ID: ID of associated Message Master
MSG_BLDR_DETAIL_ID: Unique ID for each row created
MSG_BLDR_CATEGORY_ID
MSG_BLDR_ELEMENT_ID
MSG_BLDR_SUB_ELEMENT_ID

MSG_BLDR_VALUE_ID

TABLE 1
Exemplary Message Detail Data Structure

| | | MSG | | | |
|---|---|---|---|---|---|
| MSG | MSG | BLDR | | MSG BLDR | MSG |
| BLDR | BLDR | CAT- | MSG BLDR | SUB | BLDR |
| MASTER | DETAIL | EGORY | ELEMENT | ELEMENT | VALUE |
| ID | ID | ID | ID | ID | ID |
| 10 | 110 | 27 | 125 | 235 | 880 |
| 10 | 111 | 22 | 98 | 201 | 790 |
| 10 | 112 | 25 | 115 | 224 | 859 |
| 10 | 113 | 27 | 126 | 237 | 884 |
| 10 | 114 | 25 | 113 | 221 | 845 |
| 10 | 115 | 22 | 100 | 204 | 796 |
| 10 | 116 | 27 | 127 | 238 | 886 |
| 10 | 117 | 22 | 99 | 202 | 792 |
| 10 | 118 | 25 | 116 | 225 | 862 |
| 10 | 119 | 27 | 125 | 236 | 882 |

Table 1 illustrates an exemplary message detail data structure that could be generated by the notification service and sent to the IMDS Of particular importance are the codes in the columns labeled “MSG_BLDR_SUB_ELEMENT_ID” and “MSG_BLDR_VALUE_ID”. These codes are used as indexes into an application-specific script component data structure, such as that shown in Table 2, below. Generally, the application-specific script component data structure provides script components associated with application-specific data categories.

In some embodiments, the codes (e.g., component IDs, Subelement IDs, Element IDs, Value IDs, etc.) in the data structures described herein can be system generated to ensure that no codes are improperly used to mean two different things. However, generation of the codes is not limited to system generation.

Supplemental data 308 can include, but is not limited to, data elements related to the particular application. In the case of an assisted living environment, the supplemental data 308 may include phrases related to a resident receiving care from an assisted living facility. Thus, for example, supplemental data 308 may include survey questions, special dates, personal necessities, reasons for the message, actions taken, and others related to the subject. A particular example is illustrated in FIG. 4 and described in detail below.

The message builder uses the application message 302, the application-specific script component dictionary 232, the extensible script component dictionary 230, a script template 240, the subscriber profile 238 and the subject profile 236 to generate script 310. To illustrate, FIG 4 presents specific exemplary data for each of the data elements. Prior to describing FIG. 4 in detail, embodiments of an exemplary application-specific script component dictionary, and exemplary extensible script component dictionary are presented, and will be used in the illustration of FIG. 4.

Table 2, shown below, is an exemplary application-specific script component dictionary 232 in accordance with one embodiment. The application to which data in Table 2 relates is long term assisted living care application.

TABLE 2
Exemplary Application-Specific Script Components Table

| MSG BLDR | | | | |
|---|---|---|---|---|
| SUBELEMENT | MSG BLDR | | VALUE | SEGMENT DATA |
| ID | VALUE ID | NAME | NAME | (translation) |
| 201 | 790 | Supplements | Yes | has been taking dietary supplements |
| | | | | based on the care plan |
| 201 | 791 | Supplements | No | has been refusing the intake of dietary |
| | | | | supplements |
| 202 | 792 | Swallowing Difficulties | Yes | is having difficulties swallowing |
| 202 | 793 | Swallowing Difficulties | No | is able to swallow normally |
| 204 | 796 | Mechanical Soft | Yes | has been eating mechanically softened |
| | | | | food |
| 204 | 797 | Mechanical Soft | Yes | has not been eating mechanically |
| | | | | softened food |
| 221 | 845 | Dehydrated | Yes | has been dehydrated |
| 221 | 846 | Dehydrated | No | has not been dehydrated |
| 224 | 859 | Shortness Of Breath | Yes | has struggled with breathing, when |
| | | | | moving about during the day |
| 224 | 860 | Shortness Of Breath | No | had no problems breathing |
| 225 | 861 | Labs | Yes | had lab results |
| 225 | 862 | Labs | No | had no lab results for this period |
| 235 | 880 | Outings | Yes | attended the regularly scheduled |
| | | | | activity |
| 235 | 881 | Outings | No | did not attend the regularly scheduled |
| | | | | activity |
| 236 | 882 | Facility Gathering | Yes | attended the most recently scheduled |
| | | | | facility gathering |
| 236 | 883 | Facility Gathering | No | did not attend the last facility |
| | | | | gathering |
| 237 | 884 | Ornament Decorating | Yes | last Wednesday, <<origin_nick_name>> |
| | | | | participated in a Christmas ornament |
| | | | | decorating activity |
| 237 | 885 | Ornament Decorating | No | <<origin_nick_name>> missed last |
| | | | | Wednesday's Christmas ornament |
| | | | | decorating activity |
| 238 | 886 | Local Carolers | Yes | Carolers from, Blevins Junior High |
| | | | | School, visited Columbine Care Center |
| | | | | West, and sang Christmas songs for the |
| | | | | residents.</sentence><sentence>Your |
| | | | | <<origin_nick_name>>, listened to the |
| | | | | songs, and joined in, as the whole |
| | | | | group sang, Silent Night. |

In Table 2, the column labeled “Msg Builder Subelement ID” includes application-specific codes that are used to indicate a corresponding name and segment. The column labeled “Msg Builder Value ID” includes possible values associated with the codes in the first column. The column labeled “Name” provides a name associated with the code in the first column. The column labeled “Value Name” provides a name associated with the value ID in the second column. The column labeled “Segment Data” includes an actual phrase corresponding to the value ID and value name. Thus, for example, a response of “Yes” as to whether the resident is taking her supplements corresponds to code 201 (“Supplements”), code value 790 (“Yes”) and segment data “has been taking dietary supplements based on the care plan.”

The application-specific script components data structure includes subelements of data and values related to the data subelements. The values can be obtained during the message data collection by the notification application. In one embodiment, when message data is gathered by the notification application from the service provider, the application maps the data entries to associated codes in the “Message Builder Subelement ID” and/or “Message Builder Value ID” columns. The notification application then creates a data structure such as the Message Detail Data Structure and the Message Master Data Structure shown above.

In one embodiment, the message builder can use Message Detail Data Structure (e.g., Table 1) and the application-specific script components data structure (e.g., Table 2) in conjunction to determine the script segment. Both tables include columns labeled “Message Builder Subelement ID” and “Message Builder Value ID”. The message builder 210 first looks in Table 1 for a specified Subelement ID (specified in the script template, as discussed herein), and obtains the Value ID that was entered during the message data recording by the notification application. Using the determined Value ID, the message builder 210 determines the proper script segment from Table 2.

One or more data categories in the exemplary Table 2 can be industry-specific. For example, the data category “Swallowing Difficulties” corresponds to data categories specified in the Minimum Data Set (MDS) 2.0, which is a standard data set used by the assisted living industry. However, the application-specific script component dictionary 232 is not limited to MDS 2.0 data categories. When the IMDS is used for another industry (e.g., automotive, newborn babies, etc.), standard data categories for that industry can be used.

Data in the application-specific script component dictionary 232 can be obtained from multiple sources. For example, in the context of the assisted living facility, some script segments may be obtained from a clinical recording chart from a vendor, such as MCKESSON, ADL DATA SYSTEMS, or KEANE. Script segments from other sources can be defined in the application-specific script component dictionary with their own identifiers.

Table 3 below is an exemplary extensible script components table in accordance with one embodiment. Table 3 includes three types of segment types: Assisted Living Provider types, English types, and voice extensible markup language (VXML) types.

TABLE 3
Exemplary Extensible Script Components Table

| | | SCRIPT | |
|---|---|---|---|
| SEGMENT | | COMPONENT | |
| TYPE | SEGMENT NAME | ID | SEGMENT DATA |
| Assisted | Message Category | 10089 | <<adl>> |
| Living | | | |
| Provider | | | |
| | Message Category | 10088 | <<facility_activities>> |
| | Message Category | 10087 | <<health_conditions>> |
| | Message Category | 10090 | <<medication>> |
| | Message Category | 10086 | <<oral_nutrition>> |
| | subject_first_name | 10066 | <<subject_first_name>> |
| | subject_full_name | 10065 | <<subject_full_name>> |
| | subject_gender | 10069 | <<subject_gender>> |
| | subject_last_name | 10067 | <<subject_last_name>> |
| | subject_nick_name | 10068 | <<subject_nick_name>> |
| | recipient_first_name | 10059 | <<recipient_first_name>> |
| | recipient_full_name | 10058 | <<recipient_full_name>> |
| | recipient_gender | 10064 | <<recipient_gender>> |
| | recipient_last_name | 10060 | <<recipient_last_name>> |
| | recipient_nick_name | 10061 | <<recipient_nick_name>> |
| | recipient_subject_nick_name | 10062 | <<recipient_subject_nick_name>> |
| | target_relationship | 10063 | <<recipient_relationship>> |
| | Message Category | 10091 | <<vital_signs>> |
| | ChartBuilder | −1 | Chartbuilder |
| | greeting 1 | 10070 | greetings |
| | greeting 2 | 10071 | hello |
| | greeting 3 | 10072 | hi |
| | announcement 1 | 10073 | this is abc notification |
| | | | service calling |
| | announcement 2 | 10074 | this is a message from abc |
| | | | notification service |
| | ABC notification service | 10077 | health status update |
| | Message Category | 10080 | oral nutrition |
| | Message Category | 10081 | facility activities |
| | Message Category | 10082 | health conditions |
| | Message Category | 10083 | adl |
| | Message Category | 10084 | medication |
| | Message Category | 10085 | vital signs |
| | Message element | 10092 | diet |
| | Message element | 10093 | supplements |
| | Message element | 10094 | swallowing difficulties |
| | Message element | 10095 | vomiting |
| | Message element | 10096 | urinary track infection |
| English | punctuation space | 30112 | |
| | punctuation exclamation | 30118 | ! |
| | punctuation double | 30117 | ” |
| | quotation | | |
| | punctuation apostrophe | 30113 | ' |
| | punctuation single | 30123 | ’ |
| | quotation | | |
| | pronoun | 30173 | about |
| | subordinate conjunction | 30137 | after |
| | time 1 | | |
| | subordinate conjunction | 30149 | although |
| | opp 1 | | |
| | coordinating conjunction 2 | 30128 | and |
| | pronoun | 30166 | are |
| | subordinate conjunction | 30146 | as |
| | c + e 4 | | |
| | subordinate conjunction | 30143 | because |
| | c + e 1 | | |
| | subordinate conjunction | 30138 | before |
| | time 2 | | |
| | correlative conjunction 1 | 30133 | both |
| | coordinating conjunction 4 | 30130 | but |
| | pronoun | 30167 | calling |
| | pronoun | 30174 | concludes |
| | verb | 30162 | consists |
| | verb | 30161 | contains |
| | correlative conjunction 2 | 30134 | either |
| | subordinate conjunction | 30157 | even if |
| | cond 5 | | |
| | subordinate conjunction | 30151 | even though |
| | opp 3 | | |
| | verb | 30160 | follows |
| | coordinating conjunction 1 | 30127 | for |
| | subordinate conjunction | 30153 | if |
| | cond 1 | | |
| | subordinate conjunction | 30158 | in case |
| | cond 6 | | |
| | subordinate conjunction | 30147 | in order that |
| | c + e 5 | | |
| | pronoun | 30172 | information |
| | verb | 30159 | is |
| | pronoun | 30171 | message |
| | correlative conjunction 3 | 30135 | neither |
| | coordinating conjunction 3 | 30129 | nor |
| | correlative conjunction 4 | 30136 | not only |
| | subordinate conjunction | 30145 | now that |
| | c + e 3 | | |
| | preposition | 30163 | of |
| | subordinate conjunction | 30155 | only if |
| | cond 3 | | |
| | coordinating conjunction 5 | 30131 | or |
| | plural | 30126 | s |
| | subordinate conjunction | 30141 | since |
| | time 5 | | |
| | coordinating conjunction 6 | 30132 | yet |
| | pronoun | 30170 | your |
| vxml | vxml paragraph end | 20013 | </paragraph> |
| | vxml sentence end | 20015 | </sentence> |
| | vxml paragraph begin | 20012 | <paragraph> |
| | vxml sentence begin | 20014 | <sentence> |

In Table 3, the column labeled “Segment Type” includes names of the different segment types. The next column, labeled “Segment Name” provides a name of a segment. The column labeled “Segment Component ID” includes codes for the corresponding segment. The column labeled “Segment Data” includes the text, grammar, or tagged data in the script segment.

Extensibility allows for the notification service to add to and edit the extensible script component dictionary. In one embodiment, the IMDS can include the “English” and “VXML” segment types by default and the notification service can add the “Assisted Living Provider” segment types. In this manner, the notification service can create phrases that express the same meaning in different styles. For example, the notification service can create multiple greetings as shown in Table 1: greeting 1 is “greetings”, greeting 2 is “hello”, and greeting 3 is “hi”.

In an embodiment, extensibility also enables the notification service to create different message categories and different message elements. For example, Table 3 includes message categories for ‘adl’ (activities of daily living), ‘facility activities’, ‘health conditions’, ‘health status update’, ‘medication’, ‘oral nutrition’, ‘vital signs’. Message elements include 'supplements’, 'swallowing difficulties’, ‘diet’, ‘vomiting’, and ‘urinary tract infection’.

Turning now to FIG. 4, a simplified example is described for convenience of illustration. FIG. 4 will be described with reference to Tables 2 and 3 above. In the example shown, a portion of a selected script template 402, message detail data structure 404, and supplemental data 406 are input to the message builder 210. The Message Builder 210 acquires the all the pieces for assemblage. In the script template 402, exemplary script component IDs include codes: 20012, 20014, 10071, 30112, 10059, 30120, 20015, 20014, 10073, 30173, 10068, 30120, 20015, 30112, and 10068. The message detail data structure 404 includes exemplary codes, such as message builder subelement ID 201 and message builder value ID 790.

The exemplary supplemental data 406 includes phrases: Personal Necessity: <<subject_nick_name>> is in need of a new robe; Special Dates: <<subject_nick_name>> birthday is <<subject_birthday>>; Reasons and Actions: The reason for this message is to notify you of health status of <<subject_nick_name>>.

In one embodiment, the message builder 210 accesses the associated subject profile 408 and subscriber profile 410 and builds a script 412 based on profile data. For example, only categories of information the subscriber is interested in may be included; or only information the subject allows to be released as indicated by their respective profiles. Thus, the subscriber profile 408 serves as a mechanism for messages to be customized for the subscriber.

Using the exemplary Table 2 (above) for the application-specific script component dictionary 414 and Table 3 (above) for the extensible script component dictionary 416 and the selected script template 402, a script can be created. Table 4 illustrates an exemplary selected script template with data corresponding to the data shown in the exemplary scenario:

TABLE 4
Exemplary Script Template

| | | SCRIPT | MESSAGE |
|---|---|---|---|
| SCRIPT | BUILD | COMPONENT | BUILDER |
| ID | ORDER | ID | SUBELEMENT ID |
| 1 | 1 | 20012 | −1 |
| 1 | 2 | 20014 | −1 |
| 1 | 3 | 10071 | −1 |
| 1 | 4 | 30112 | −1 |
| 1 | 5 | 10059 | −1 |
| 1 | 6 | 30120 | −1 |
| 1 | 7 | 20015 | −1 |
| 1 | 8 | 20014 | −1 |
| 1 | 9 | 10073 | −1 |
| 1 | 10 | 30173 | −1 |
| 1 | 11 | −1 | 201 |
| 1 | 12 | 10068 | −1 |
| 1 | 13 | 30120 | −1 |
| 1 | 14 | 30112 | −1 |
| 1 | 15 | 10068 | −1 |
| | | . | |
| | | . | |
| | | . | |

In Table 4, each row corresponds to a segment of the script. The column labeled “Script ID” uniquely identifies the script. The column labeled “Build Order” provides numbers that indicate the order in which the script segments should be processed. The next columns, labeled “Script Component ID”, and “Message Builder Subelement ID”, provide data that is mutually exclusive, which means that the message builder 214 uses data from only one of the columns. In this embodiment, the column that includes a non-negative value is to be used for the corresponding segment when building the human-understandable message.

A script template can be embodied in any number of ways and formats as may be known by those skilled in the art. In one embodiment, the script template is embodied in an extensible markup language (XML) document. In other embodiments, script templates can be coded in a computer language such as ‘C’ programming language. In yet another embodiment, script templates can be created in an intermediate language, such as Java Bytes that can be interpreted by a virtual machine. The script template is used by the IMDS to generate a script, which can be delivered to a recipient as a human-understandable message.

The column labeled “Script Component ID” can include a list of unique script component identifiers in the form of codes. The codes can correspond to application-specific scripts and/or application-specific translations. The column labeled “Message Builder Subelement ID” can include a list of unique codes for data elements to be put in the script 412. The Message Builder Subelement IDs in Table 4 can be found in the Message Detail Data Structure shown in Table 1 above. The Message Builder Subelement ID and the Message Builder Subelement ID Value in Table 1 can be used to access a corresponding script segment from Table 2, the application-specific script component dictionary.

According to the present example, the message builder 210 steps through each portion of the script template according to the “Build Order”. For each component, if the script build data structure includes a non-negative value in the “Script Component ID”, the message builder 210 accesses the extensible script component dictionary 416 to resolve the code. If the component of the script build data structure includes a non-negative value in the “Message Builder Subelement ID”, the message builder accesses a message detail data structure 404 and the application-specific translations dictionary 414 to resolve the code.

Using the script template 402, the message builder 210 steps through the script segments in the specified order and looks each one up in the appropriate dictionary or data source. Using Tables 2 and 3 shown above, the script component IDs are mapped to the following corresponding script segments:
20012=<paragraph>
20014=<sentence>
10071=hello
30112=<space>
10059=<<recipient_first_name>>
30120=.
20015=</sentence>
20014=<sentence>
10073=this is abc notification service calling
30173=about
10068=<<subject_nick_name>>
30120=.
20015=</sentence>
30112=<space>
20014=<sentence>
10068=<<subject_nick_name>>
201, 790=has been taking dietary supplements based on the care plan
30120=.
20015=</sentence>

Items tagged with double arrows (i.e., <<>>) indicate a context-sensitive segment. In this case, the context-sensitive segment is filled in using with content obtained from either the subject profile 408 or a subscriber profile 410. In this particular example, the tagged item <<subject_nick_name>>is replaced with ‘Granny’. The tagged item <<recipient_first_name>>is replaced with ‘Joe’.

After the script 412 is created, the message builder 210 merges the supplemental data 406 with the script 412. In the example shown, supplemental data 406 includes three data segments: personal necessity, special dates, and reasons and actions related to the message. Personal necessity refers to an item that the resident needs. Special dates refer to any special dates related to the resident. Reasons and actions provide reasons for the message and actions that may have been taken. Supplemental data 406 can include other information, such as, but not limited to, survey questions. When the message builder 210 is used to generate messages in industries other than the assisted living industry, supplemental information can include data segments associated with the particular industry or application.

In this particular example, when the supplemental data 406 is merged with the script, the script 412 results in:

“<paragraph><sentence>Hello Joe. </sentence><sentence> This is abc notification service calling about Granny.</sentence><sentence> Granny has been taking dietary supplements based on the care plan. </sentence> . . . <sentence> Granny's birthday is June 11. </sentence><sentence> Granny is in need of a new robe. </sentence><sentence> Would you like to purchase a new robe for Granny? </sentence>”

For purposes of completing the exemplary scenario shown in FIG. 4, in one embodiment, a voice gateway calls the subscriber and, after verifying the subscriber, communicates the script using text-to-speech (TTS) conversion. The subscriber is enabled to respond to the question “Would you like to purchase a new robe for Granny?”). In one embodiment, the subscriber can respond by voice, in which case, the voice gateway uses voice recognition to encode and determine the response. In another embodiment, the subscriber can respond by pressing a button on his/her phone, in which case, the voice gateway determines the response using dual tone modulation frequency (DTMF).

The voice gateway communicates the subscriber's response to the intelligent message delivery system (IMDS). The IMDS can deliver the subscriber's response to the notification application. In some embodiments, the notification application can carry out tasks in response to the subscriber's response. For example, if the subscriber does want to purchase the robe for his/her grandma, the notification application can order the robe from an online retailer via the Internet. Conveniently, the notification application already has the subscriber's credit card information from the subscriber profile. Therefore, the notification application can bill the credit card and order the robe for delivery on behalf of the subscriber with no further effort on the part of the subscriber.

Exemplary Operations

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

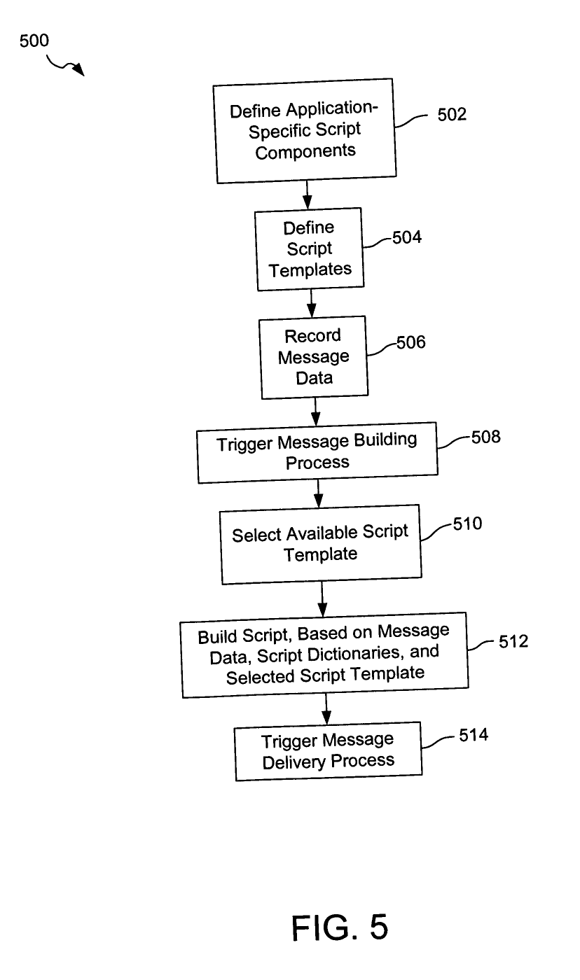

FIG. 5 illustrates an algorithm 500 for creating a script based on dynamically generated application message data, predefined script components and a predefined script template. The algorithm 500 may be carried out by one or more of the systems illustrated in FIG. 1 (e.g., the notification service 114 or the IMDS 102).

Before scripts can be built and messages delivered, script components and one or more script templates are defined. In a defining operation 502, application-specific script components are defined. Application-specific script components can be defined in an application-specific script component data structure, such as that shown in Table 2. The application-specific script components can include industry-specific data categories. Alternatively, or in addition, application-specific script components can be defined in an extensible script component data structure.

In one embodiment, the defining operation 502 occurs when an application is registered by a notification service. In accordance with this embodiment, this can involve an administrator at the notification service accessing a user interface to define and enter script components. In another embodiment, the administrator can build the script component definitions in a document and send the document to the intelligent message delivery system (IMDS). In yet another embodiment, the intelligent message delivery system can provide a list of script components to choose from.

In a particular embodiment, the script components defined in the defining operation 502 are stored in one or more data structures at the IMDS, such as script component dictionaries, from which they can be retrieved for use in building a script.

Another defining operation 504 defines one or more script templates. Defining a script template involves defining an order of script segments identified in the predefined script components. A portion of an exemplary script template is shown above in Table 4. In one embodiment, every script template has a specified number of script segments. In one embodiment, the script templates are defined by a user through a user interface (e.g., a graphical user interface GUI) that includes a drop down list of possible script components to include in the script template.

In one embodiment, the script templates can be categorized according to an associated data category, data element, data subelement, or other criteria. For example, script templates referencing health status of residents in an assisted living facility may be in one category, while script templates referencing activities of daily living may be in another category.

In one embodiment, the defining operation 504 involves defining many script templates (e.g., hundreds or thousands) so that a large variety of messages can be produced. Each script template can order categories of script segments in different orders. For example, in one script template, health status may come before activities of daily living, while in another script template activities of daily living comes before health status. In addition, different styles of phrasing may be used in different script templates. For example, one script template may include a script segment “Greetings” as the introductory greeting, while another script template includes a script segment “Hello” as the introductory greeting, while still another script segment includes “Hello <<recipient_first_name>>” as the introductory greeting. By creating multiple script templates with different ordering of script segments and different styles of phrasing, scripts and messages can be built that sound new (i.e., fresh) to the recipient.

After the script components and the script templates are defined, application message data is generated and recorded dynamically in a recording operation 506. In one embodiment, the recording operation 506 involves the notification service recording message data retrieved from the service provider. In this embodiment, a user at the service provider can enter message data through a user interface. The application of the notification service records the message data in the form of codes (e.g., script component IDs) and other supplemental data (e.g., alphanumeric text, phrases, etc.). The codes and supplemental data can be application-specific. For example, for an assisted living service provider, codes can correspond to categories of assisted living care, and supplemental data can correspond to supplemental data related to a subject. In one embodiment, the application sends the message data to the IMDS.

A triggering operation 508 triggers a message building process to build a script based on the message data. A selecting operation 510 selects a script template from one of the predefined script templates. The selected script template will be used to create the script. A building operation 512 builds the script using the message data, predefined script component dictionaries, and the selected script template. In one embodiment, the building operation 512 also uses a subscriber profile and a subject profile to facilitate generation and/or customization of the script. After the script is built, another triggering operation 514 triggers a message delivery process to cause the script to be converted to a human-understandable message and delivered to the subscriber.

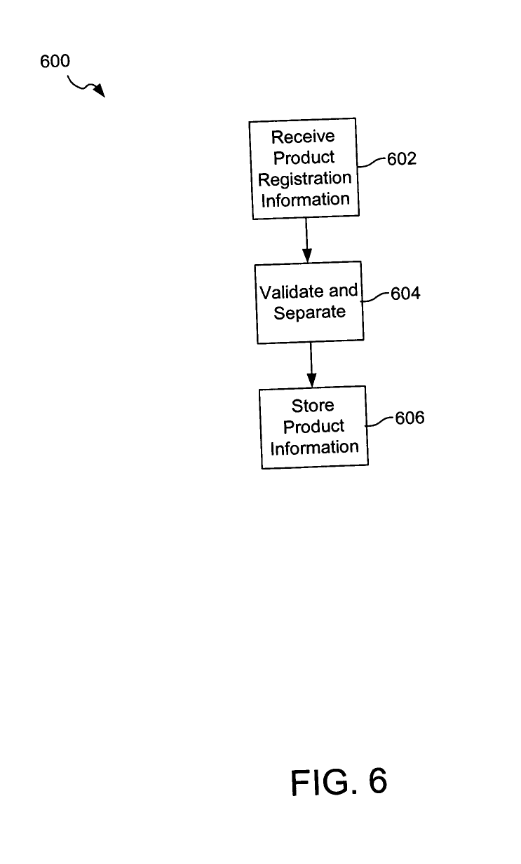

FIG. 6 illustrates an exemplary embodiment of a application registration algorithm 600 that can be performed by the IMDS manager 202. As discussed above, notification services can register one or more applications with the IMDS. In one embodiment, the IMDS manager 202 handles registration of applications according to the algorithm 600.

In a receiving operation 602 receives application registration information. This can include application name and description. A validating operation 604 validates the received application registration information. In one embodiment, the application registration information will be stored in a relational database. As such, the application registration information is validated according to the rules of the relational database. Because the application registration information can be stored in multiple tables in the relational database, the validating operation 604 also separates the application registration information for storage in the appropriate tables. A storing operation 606 stores the separated application registration information in the appropriate tables of the relational database.

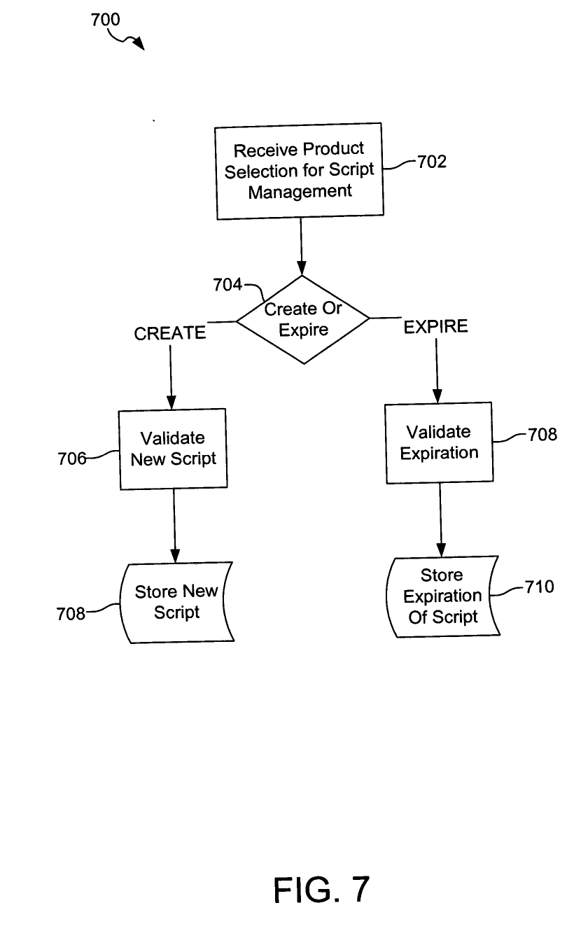

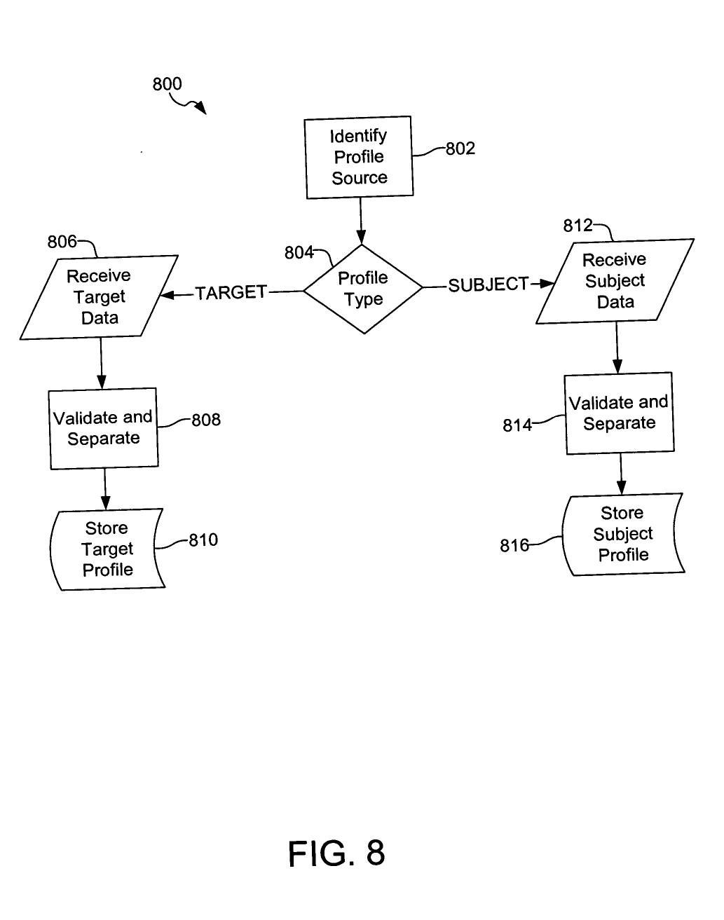

FIG. 7 illustrates an exemplary embodiment of a script management algorithm 700 that can be performed by the IMDS manager 202. As discussed above, the IMDS provides an extensible script component dictionary. New script components can be created or expired. The algorithm 700 generally involves the process of creating new script components and expiring unwanted script components.

A receiving operation 702 receives an indication of a application for which a script component will be added or expired. In one embodiment, the receiving operation 702 receives the indication through a webpage interface. Also received through the webpage interface is an indication whether a script component is to be created or expired.

A determining operation 704 determines whether a script component is being added or expired. If a script component is being created, the algorithm 700 branches “CREATED” to a validating operation 706. The validating operation 706 determines if the script component is valid (e.g., proper format, etc.). A storing operation 708 stores the newly created script in a database.

If the determining operation 704 determines that a script component is to be expired, the algorithm 700 branches “EXPIRE” to another validating operation 710. The validating operation 710 checks to ensure that the expiration is valid. The validation process checks weather the script has been assigned for delivery during the next delivery period (e.g., the current week). If it has, the expiration date is set for the beginning of the following delivery period (e.g., the next week); else the script is expired immediately. If the expiration is valid, a storing operation 712 stores the expiration of the script component. In one embodiment, the storing operation 712 deletes the script component. In another embodiment, the storing operation 712 marks the script component as expired so that it is not used.

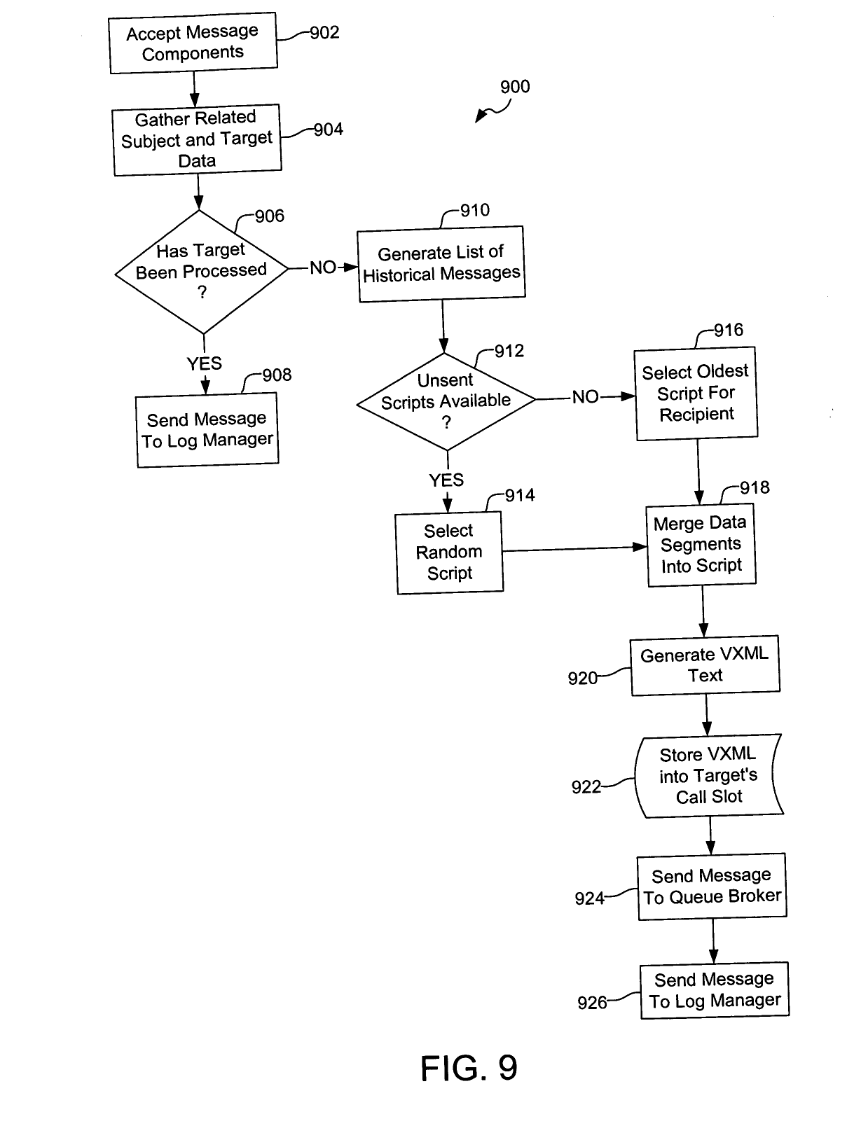

FIG. 9 illustrates an exemplary embodiment of a profile management algorithm 900 that can be performed by the profile manager 206. The profile management algorithm 900 generally enables a user (e.g., an administrator at a notification service) to create profiles for subjects and targets (e.g., subscribers). When a notification service requests to create a new profile, an identifying operation 902 identifies the type of profile. In one embodiment, a web page interface accepts input that identifies the type of profile.

A determining operation 904 determines what type of profile is to be created. If the type of profile is a target profile, the algorithm 900 branches “TARGET” to a receiving operation 906. The receiving operation 906 receives the profile information, such as target name, nickname, address, phone number, credit card, relationship to subject, etc. A validating operation 908 validates the target profile data according to rules of a relational database. In one embodiment, the rules pertain to data types and null values. If null values exist, then appropriate system defined defaults are assigned. In this embodiment, the profile data can be stored in multiple database tables. As such, the data is separated to be stored in the appropriate database table. A storing operation 910 stores the separated profile data in the appropriate database table.

Referring again to the determining operation 904, if the type of profile is a subject profile, the algorithm 900 branches “SUBJECT” to a receiving operation 912. The receiving operation 912 receives the subject profile information, such as subject name, nickname, address, etc. A validating operation 914 validates and separates the subject profile data according to the rules of a relational database. A storing operation 916 stores the separated profile data in the appropriate database table.

FIG. 9 illustrates an exemplary embodiment of a message building algorithm 900 that can be performed by the message builder 210. Initially, a receiving operation 902 receives message components. The message components may be received via the network (e.g., from a notification service) or from local memory. The message components include the script component identifiers that will be used to generate the message. The message components may also include data elements that can be merged with scripts to form the message. The receiving operation 902 receives key information that identifies the target to receive the message and the associated subject.

A gathering operation 904 gathers data associated with the target and the subject based on the key information. In one embodiment, the gathering operation 904 accesses a target profile to determine the target's name, nickname, phone number, etc. The subject profile may be accessed for the subject's name, nickname, target relation, etc.

A determining operation 906 determines whether the target has been processed. Generally, the determining operation 906 identifies whether a message has already been generated for the target. If so, the algorithm 900 branches “YES” to a sending operation 908, which sends the message to the log manager 220. If the target has not been processed, the algorithm 900 branches “NO” to a generating operation 910.

The generating operation 910 generates a list of messages that have previously been generated and/or delivered to the target. In one embodiment, the generating operation 910 searches the log data 244 for historical messages associated with the target. A determining operation 912 determines whether any scripts are available that have not been delivered to the target. The determining operation 912 searches the available scripts 240 for any that are not in the list of historical messages.

If an unsent script is available in the available scripts 240, the algorithm 900 branches “YES” to a selecting operation 914. To achieve message freshness, the selecting operation 914 selects an available unsent script at random. It is to be understood that selection of an unsent available script is not limited to a random selection. In other embodiments, the script may be selected according to a specified order, or based on events related to the content of the message, or others.

However, if an unsent script is not available in the available scripts 240, the algorithm 900 branches “NO” to another selecting operation 916. The selecting operation 914 selects the least recently sent available script. After a script has been selected in either the selecting operation 914 or selecting operation 916, a merging operation 918 merges data elements with the selected script.

Alternatively, as discussed above, freshness of message content may be achieved by presenting the scripts in a different order than the historical messages.

In one embodiment, a generating operation 920 generates a VXML document based on the message. Generally, the generating operation 920 adds VXML tags in the message that provide TTS processing information to a TTS system, so that the message can be converted from text to speech. TTS and conversion from text to speech is discussed further below with regard to the message delivery algorithm.

A storing operation 922 stores the VXML document in a call slot associated with the target. A sending operation notifies the queue broker 208 that the message has been generated and is ready for delivery at the scheduled time. Another sending operation 926 sends message generation status information to the log manager 220.

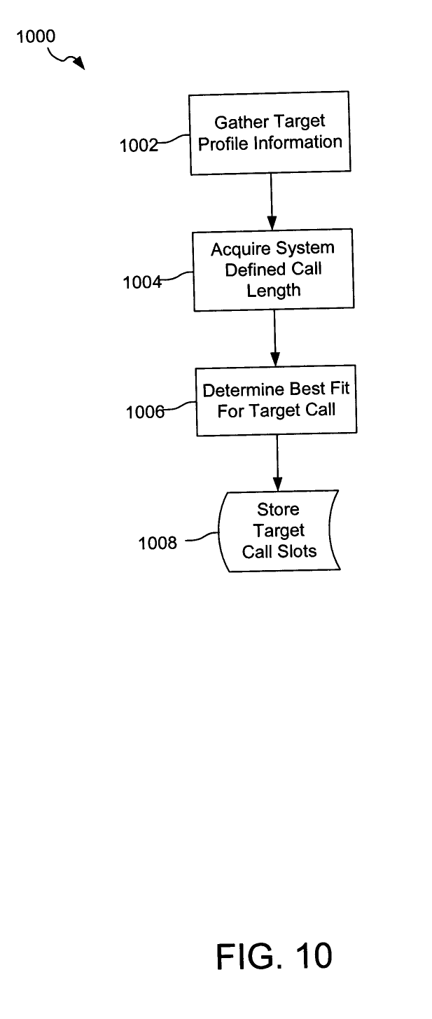

FIG. 10 illustrates an exemplary embodiment of a message scheduling algorithm 1000 that can be performed by the message scheduler 212. In general, the message scheduling algorithm 1000 schedules an available message in an appropriate call slot, so that the message will be delivered to a recipient at a specified time. Initially, a gathering operation 1002 gathers the recipient's profile information. The profile information specifies a service level and a time range (e.g., between 7:00 pm and 9:00 pm, Saturday night) that the recipient would prefer to have messages delivered.

An acquiring operation 1004 acquires a system defined call length. The system defined call length is a parameter that dictates the number of calls that can be handled. The system defined call length typically depends on the available physical hardware and telephony services. A determining operation 1006 determines the delivery time for the target call based on the recipient's profile and the system defined call length. A storing operation 1008 stores the message in a call slot associated with the determined delivery time.

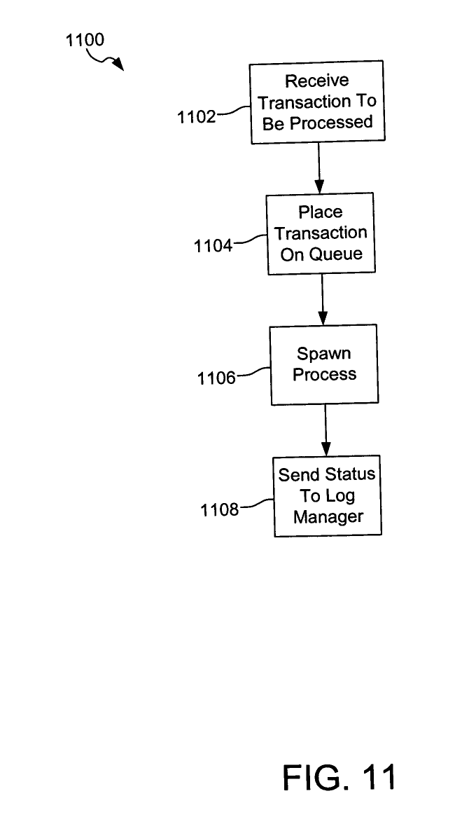

FIG. 11 illustrates an exemplary embodiment of a queue brokering algorithm 1100 that can be performed by the queue broker 208. Initially, a receiving operation 1102 receives a transaction to be processed. An example of a process that may be queued is a message delivery process. A placing operation 1104 places the transaction on the queue. The placing operation can involve choosing the proper queue and storing a reference to the transaction on the queue. The transaction is placed on the queue with an execution time.

When the execution time arrives, a spawning operation 1106 spawns (i.e., initiates) a process to perform the transaction. Spawning operation 1106 may include sending notification to an associated module in the IMDS to begin the transaction. For example, if the transaction is message delivery, the spawning operation 1106 notifies the message deliverer 214 to begin the process of delivering a message.

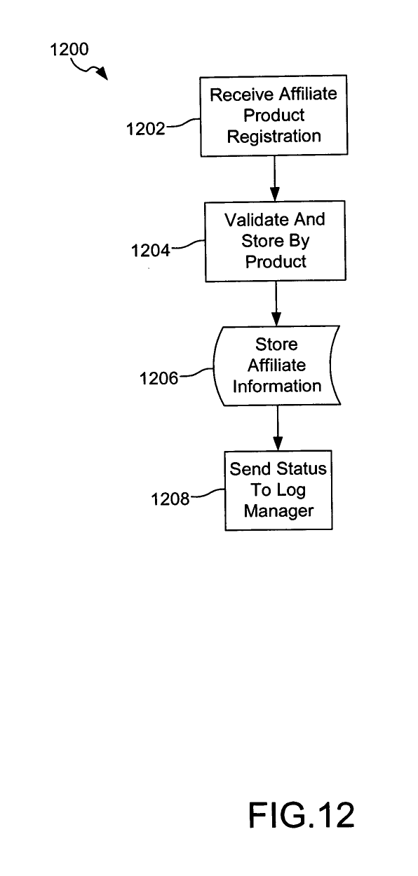

FIG. 12 illustrates an exemplary embodiment of a brokering algorithm 1200 that can be performed by the service broker 204. Generally, a registered notification service may contact the IMDS to register an affiliate application. The service brokering algorithm 1200 handles the request. Initially, a receiving operation 1202 receives the request to register the affiliate application. The receiving operation 1202 receives information about the affiliate application to be registered, such as application provider, application name, description, associated script components, and so on.

A validating operation 1204 validates the information in the registration request. If the information is valid, the affiliate registration information is stored in storing operation 1206. In the validating operation 1204 affiliate information is validated against constraints within the relational database, and stored with appropriate associations to the desired application. Application associations allow for the affiliate partners to participate with selected IMDS application offerings. A sending operation 1208 sends status related to registration of the affiliate application to the log manager 220.

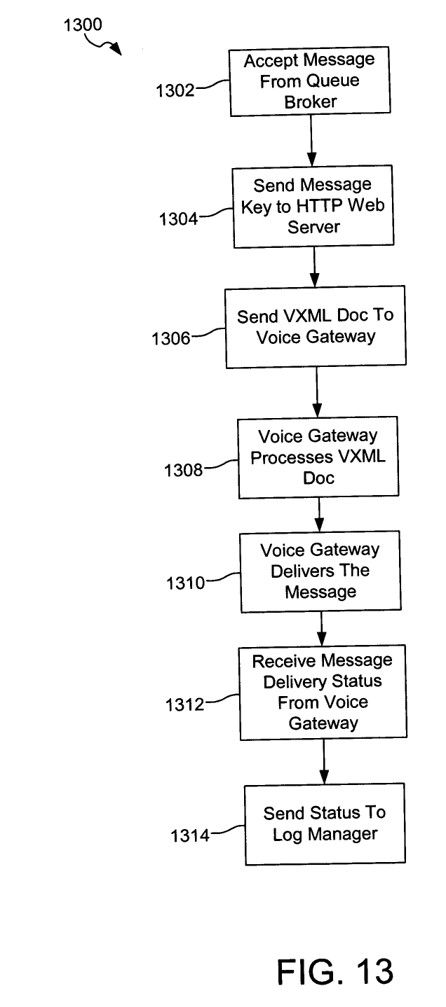

FIG. 13 illustrates an exemplary embodiment of a message delivery algorithm 1300 that may be carried out by the message deliverer 214. Initially, an accepting operation 1302 accepts a message from the queue broker. In this embodiment, the message includes a message key that indicates the recipient of the message, as well as a voice extensible markup language (VXML) document.

A sending operation 1304 sends the message key to an HTTP web server, where supporting information (i.e. the actual message, etc) is gathered about the subject and/or the subscriber which supports the delivery. In the illustrated embodiment, another sending operation 1306 sends the VXML document to a voice gateway that can process the document and deliver the human-understandable message to the recipient.

A processing operation 1308 processes VXML data in the message. This typically involves performing text-to-speech (TTS) conversion on the message. The processing step is typically carried out by the voice gateway. Exemplary products that perform TTS include AT&T Natural Voices™, Loquendo TTS, VoiceText available from NeoSpeech Inc., Prosody available from Aculab, Elan SaySo available from Elan Speech, FAAST or DECTalk available from Fonix Corporation, VoiceServer available from IBM Corporation, LTTS available from Lucent Speech Solutions, Flex Voice available from Mindmaker, Vocalizer available from Nuance Communications, rVoice available from Rhetorical Systems, SoftVoice available from SoftVoice, Inc., Hybrid Orator II available from Telcordia Technologies, VoiceText available from Voiceware Co., Ltd., or the like.

In a delivering operation 1310, the human-understandable message is delivered to the recipient. In one embodiment, the recipient is contacted by telephone and the message is audibly presented to the recipient. During message presentation, the recipient may be prompted for various information, such as survey questions, request to purchase an item for a resident of a nursing home, or others. Any responses from the recipient will be captured and communicated back to the IMDS.

A receiving operation 1312 receives delivery status from the voice gateway. Delivery status indicates whether the message was successfully delivered, and can include responses from the recipient to prompts in the message. A sending operation 1314 sends the delivery status to the log manager.

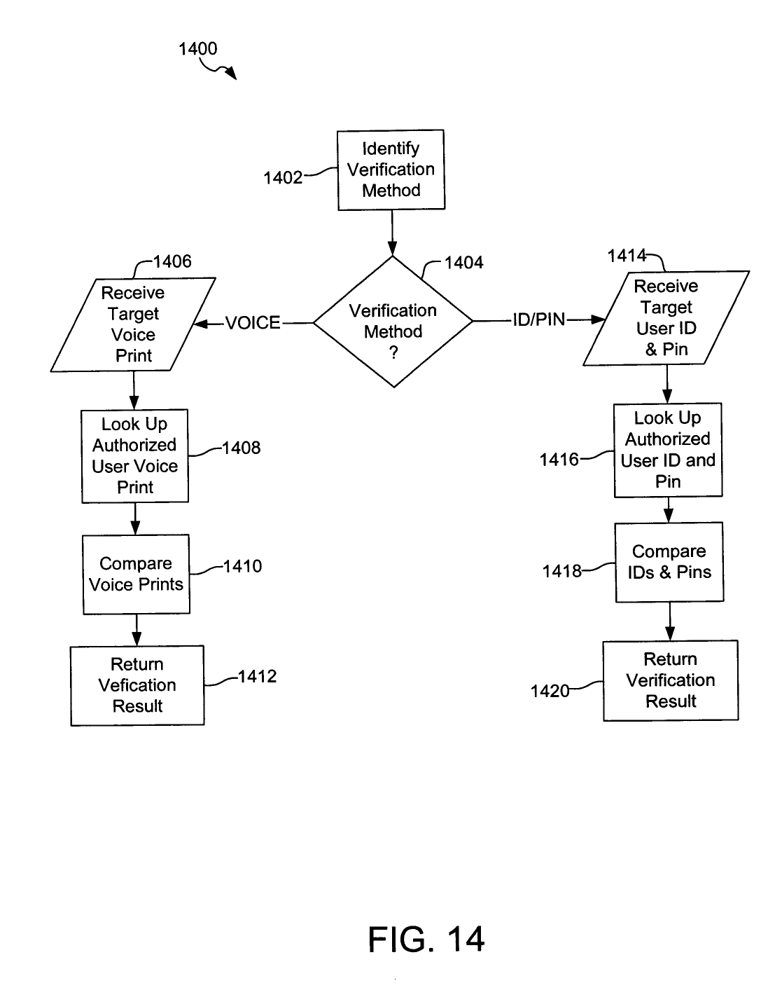

FIG. 14 illustrates an embodiment of a target verification algorithm 1400 that can be carried out by the verification manager 216. In general, the verification algorithm verifies whether a targeted recipient of a human-understandable message is authorized to receive the message. In some embodiments, more than one type of verification method may be available. Some recipients may be verified in one manner, while other recipients are verified in another manner.

As such, an identifying operation 1402 identifies the verification method associated with a recipient to be verified. The identifying operation 1402 can determine the verification method from the recipient's (or associated subscriber's) profile. A determining operation 1404 determines what type of verification method to use.

In one embodiment, the determining operation 1404 determines whether the verification method is voice verification or an ID/pin number verification. If the verification method is voice, the algorithm 1400 branches “VOICE” to a receiving operation 1406. The receiving operation 1406 receives a voice print from the target. This may involve having the target speak a specified phrase into the phone and capturing the spoken phrase in an encoded voice print.

A looking up operation 1408 looks up a corresponding authorized user's voice print. The looking up operation 1408 may access the authorized user's profile, which can include the voice print.

A comparing operation 1410 compares the target's captured voice print to the authorized user's voice print. If the two voice prints are substantially similar within a tolerance, the voice prints are considered the same and the target is successfully verified. If the two voice prints are not substantially similar within the tolerance, the voice prints are considered different and the target verification fails. A returning operation 1412 returns the status (e.g., either pass or fail).

Referring again to the determining operation 1404, if it is determined that ID and pin verification are to be used, the algorithm 1400 branches “ID/PIN” to a receiving operation 1414, which receives an ID and pin number from the target. Typically, the target enters the ID and pin via keypad, but they may also be entered via speech. If the ID and pin are received via speech, voice recognition is employed (for example, by the voice gateway) to determine the ID and pin.

Another looking up operation 1416 looks up a corresponding authorized user's ID and pin number. The looking up operation 1416 may access the authorized user's profile, which can include the ID and pin.

A comparing operation 1418 compares the ID and pin entered by the target to the authorized user's ID and pin. If the two IDs and pins match the target is successfully verified. If the two IDs and pins do not match, the target verification fails. A returning operation 1420 returns the status (e.g., either pass or fail).

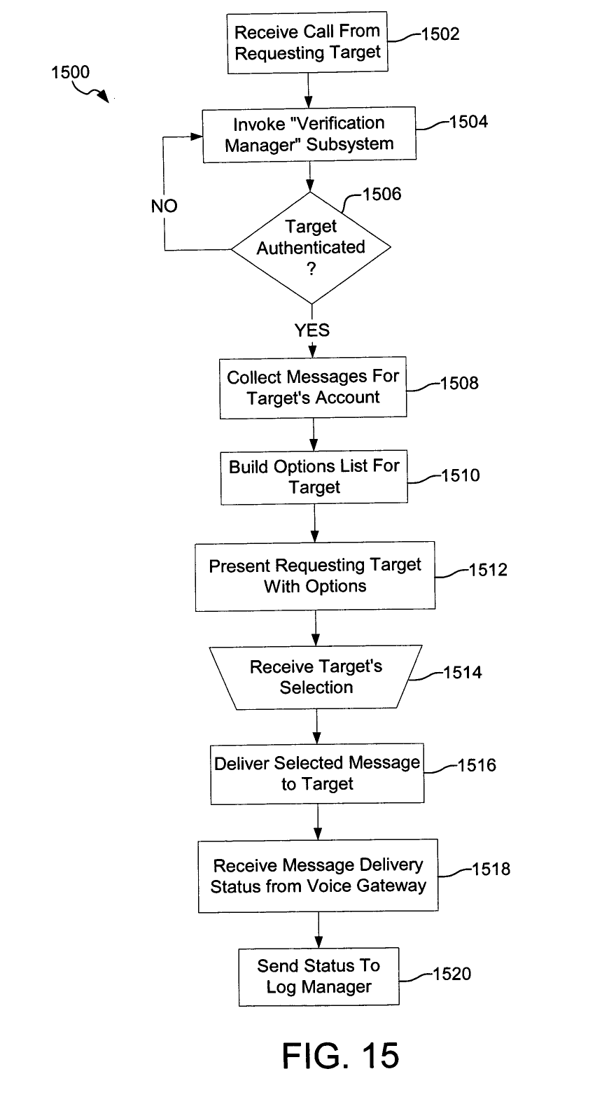

FIG. 15 illustrates an exemplary embodiment of a retrieving algorithm 1500 that may be carried out by the retriever module 216. Messages that have been generated and stored can be retrieved by a user. In a receiving operation 1502, the intelligent message delivery system (IMDS) receives a telephone call from a target user. Generally, users can dial a telephone number associated with the notification service that provides the application the target is subscribed to. In one embodiment, the call goes through a voice gateway and is routed to the IMDS.

An invoking operation 1504 invokes the verification manager 216 to collect the user's account information and verify whether the calling target user is an authorized user. In one embodiment, the IMDS instructs the voice gateway to invoke the verification manager 216. A determining operation 1506 determines whether the target user is authorized. If verification is not successful, the algorithm 1500 branches “NO” back to the invoking operation 1504, where verification is attempted again. Verification of the target may be limited to a specified number of attempts.

If verification is successful, the algorithm 1400 branches “YES” to a collecting operation 1408. The collecting operation 1408 collects any available messages associated with the target's account. A building operation 1410 builds a document listing the available messages for the target. In one embodiment, the document is a VXML document that can be audibly presented to the target. A presenting operation 1412 presents the list of available messages to the target. In one embodiment, the IMDS causes a voice gateway to present the list of available messages audibly. The presenting operation 1412 enables the target to select one or more of the messages for delivery.

A delivering operation 1414 delivers the selected message(s) to the target. In one embodiment, the delivering operation causes the voice gateway to deliver the selected message(s) to the target. A receiving operation 1416 receives status related to delivery of the message(s). In one embodiment, the message delivery status is received from the voice gateway. A sending operation 1418 sends the message delivery status to the log manager 220.

Exemplary Computing Device

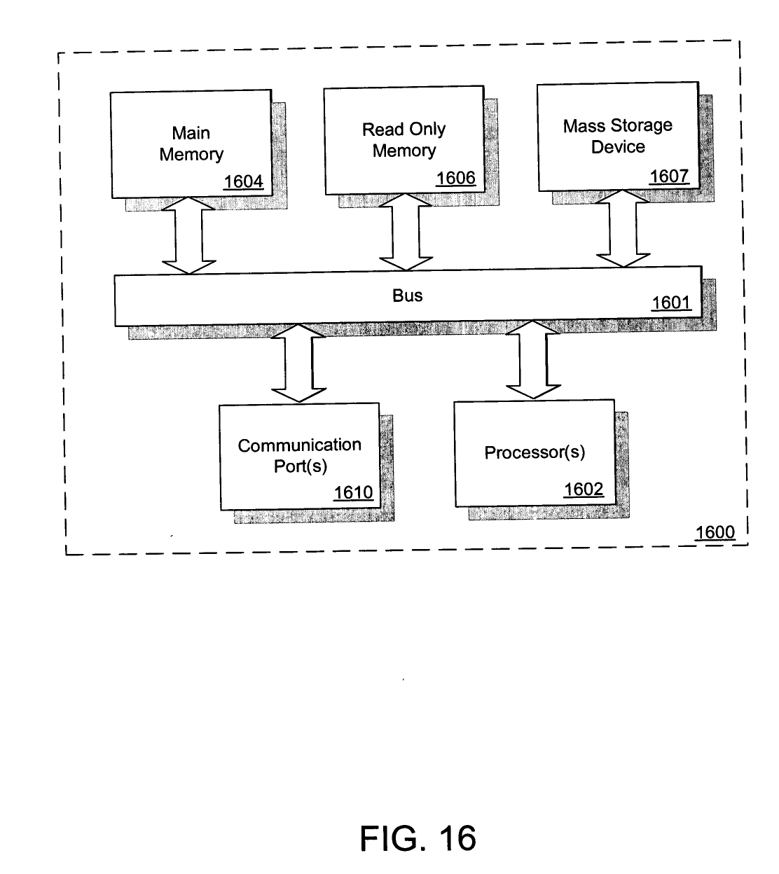

FIG. 16 illustrates an exemplary machine in the form of a computer system 1600. The computer system 1600 is representative of many types of computing devices and systems, such an exemplary database server or web server, in which features of the present invention may be implemented will now be described with reference to FIG. 16. In this simplified example, the computer system 1600 comprises a bus or other communication means 1601 for communicating information, and a processing means such as one or more processors 1602 coupled with bus 1601 for processing information.

Computer system 1600 further comprises a random access memory (RAM) or other dynamic storage device 1604 (referred to as main memory), coupled to bus 1601 for storing information and instructions to be executed by processor(s) 1602. Main memory 1604 also may be used for storing temporary variables or other intermediate information during execution of instructions by processor(s) 1602. Computer system 1600 also comprises a read only memory (ROM) and/or other static storage device 1606 coupled to bus 1601 for storing static information and instructions for processor 1602. A data storage device 1607 such as a magnetic disk or optical disc and its corresponding drive may also be coupled to bus 1601 for storing information and instructions.

One or more communication ports 1610 may also be coupled to bus 1601 for allowing communication and exchange of information to/from with the computer system 1600 by way of a Local Area Network (LAN), Wide Area Network (WAN), Metropolitan Area Network (MAN), the Internet, or the public switched telephone network (PSTN), for example. The communication ports 1610 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the computer system 1600 may be coupled to a number of other network devices, clients and/or servers via a conventional network infrastructure, such as a company's Intranet and/or the Internet, for example.

Embodiments of the present invention may be provided as a computer program product which may include a machine-readable medium having stored thereon instructions which may be used to program a computer (or other electronic devices) to perform a process according to the methodologies described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

The tables shown and described herein are for illustrative purposes only in order to illustrate how one skilled in the art could create a data structure in accordance with various embodiments. In particular embodiments data structures are not limited to those illustrated by the tables. It will be understood that values in an application-specific script components data structure are not limited to those shown in tables described herein. In addition, the arrangement of values is not limited to the arrangements shown in the tables.

The functional modules, systems, operations, and data structures discussed herein are capable of combination, separation, or any other type of rearrangement without departing from the spirit scope of the claims recited below. For example, the notification service may be combined with the service provider or the intelligent message delivery system. Data structures shown and described can be implemented in any format known to those skilled in the art including, but not limited to extensible markup language (XML), as entries in a relational database, or any proprietary format.

Although some exemplary methods, systems, and devices have been illustrated in the accompanying drawing and described in the foregoing detailed description, it will be understood that the methods and systems shown and described are not limited to the particular embodiments described herein, but rather are capable of numerous rearrangements, modifications, and substitutions without departing from the scope and spirit of the claims set forth below.

1. A method for delivering a message to a recipient, the message associated with a subject, the method comprising:
receiving an application message including one or more codes corresponding to script segments in a script component data set including a set of script segments that express a common meaning with a different phrase;
mapping each of the codes to an associated script segment in the script component data set;
generating a script composed of the associated script segments; and
causing a first human-understandable message to be delivered to the recipient, wherein the first human-understandable message is based on the generated script.

2. A method as recited in claim 1 wherein the one or more codes map to corresponding data categories referenced in the Minimum Data Set (MDS) 2.0.

3. A method as recited in claim 1 wherein said mapping comprises selecting a script segment from an application-specific script component data set that associates application-specific codes with script segments.

4. A method as recited in claim 3 wherein the script segments are derived from multiple sources.

5. A method as recited in claim 1 wherein the script component data set is extensible.

6. A method as recited in claim 1 wherein the script component data set can be extended to include application-specific script components.

7. A method as recited in claim 1, wherein the application message includes a supplemental data, wherein the method further comprises merging the supplemental data into the script.

8. A method as recited in claim 1 further comprising selecting a script template that defines the format for the script from a set of available script templates; and
generating a second human-understandable message from the randomly selected script template.

9. A method as recited in claim 8 wherein said selecting includes randomly selecting a script template.

10. A method as recited in claim 1 further comprising:
registering a application that can use the script component data set; and
receiving application-specific script components related to the application.

11. A method as recited in claim 1 further comprising:
registering a application that can use the script component data set; and
selecting an industry-specific script component data set associated with the application, the industry-specific script component data set including one or more standard industry data categories associated with script segments.

12. A system for delivering messages to a subscriber of a notification application, the system comprising:
a plurality of available script templates defining formats for scripts;
a message builder receiving application-specific data and building a script based on a previously unused script template, and merging the application-specific data with the script; and
a message delivery module causing a human-understandable message to be delivered to the subscriber, the human-understandable message being generated from the script.

13. A system as recited in claim 12 further comprising a message retriever module operable to retrieve a previously built script in response to a request from the subscriber, and notify the message delivery module to cause another human-understandable message based on the previously built script to be delivered to the subscriber.

14. A system as recited in claim 12 further comprising a script component dictionary including a plurality of script component identifiers that may be referenced by the notification application, each script component identifier associated with a script segment, and wherein a set of two or more script segments express a common meaning using a different phrase.

15. A system as recited in claim 12 wherein the message delivery module causes the script to be converted from text to synthesized speech.

16. A system as recited in claim 12 wherein the message delivery module causes the subscriber to be verified via biometric verification prior to delivery of the human-understandable message.

17. A system as recited in claim 16 wherein biometric verification comprises voice authentication.

18. A system for delivering application messages to a subscriber, the application messages associated with a subject of interest to the subscriber:
multiple script templates available for use in generating a human-understandable message, each script template defining a different script format;
means for selecting a script template in a manner that ensures that a previously unselected script template will be used to generate the human-understandable message; and
means for enabling an application to select script segments to include in the human-understandable message.

19. A system as recited in claim 18 wherein the means for enabling comprises a memory embodying a script component data set that associates script component codes with script segments.

20. A system as recited in claim 19 wherein the application can create and expire application-specific script components in the script component data set.

21. A system as recited in claim 18 wherein the means for selecting a script comprises a processor executing instructions that cause the processor to randomly select one of the available script templates.

22. A system as recited in claim 18 wherein the means for enabling comprises a memory having stored thereon an application-specific script component data set associating one or more industry standard data categories with corresponding script segments, the script segments being selectable by the application for inclusion in the human-understandable message.

23. A system as recited in claim 18 further comprising means for causing the human-understandable message to be securely delivered to the subscriber by verifying biometric data associated with the subscriber prior to delivery of the human-understandable message.
